(19) United States
(12) Patent Application Publication
(10) Pub. No.: US 2022/0046669 A1
(43) Pub. Date: Feb. 10, 2022

(54) CONFIGURATION OF UPLINK HYBRID AUTOMATIC REPEAT REQUEST PROCESSES AND PROCESS TYPES

(71) Applicant: QUALCOMM Incorporated, San Diego, CA (US)

(72) Inventors: Xiao Feng WANG, San Diego, CA (US); Liangping MA, San Diego, CA (US); Alberto RICO ALVARINO, San Diego, CA (US); Bharat SHRESTHA, San Diego, CA (US); Umesh PHUYAL, San Diego, CA (US); Peter GAAL, San Diego, CA (US); Dan ZHANG, San Diego, CA (US); Ayan SENGUPTA, San Diego, CA (US)

(21) Appl. No.: 17/391,894

(22) Filed: Aug. 2, 2021

Related U.S. Application Data
(60) Provisional application No. 63/061,629, filed on Aug. 5, 2020.

(51) Int. Cl. H04W 72/12; H04W 72/14; H04W 72/04; H04L 1/18

(52) U.S. Cl. CPC H04W 72/1268; H04W 72/14; H04L 1/1819; H04W 72/0446; H04W 72/0413

(57) ABSTRACT

In a communication between a user equipment (UE) and a network node, the UE may receive an uplink (UL) grant physical uplink shared channel (SCH) resources from the network node. The UE may transmit an UL message on the PUSCH using a transmit configuration in accordance with the associated HARQ process. The transmit configuration may be one of a plurality of transmit configurations. At least two of the plurality of transmit configurations may be configured for different HARQ processes.

### CROSS-REFERENCE TO RELATED APPLICATION

The present Application for Patent claims the benefit of U.S. Provisional Patent Application No. 63/061,629 entitled “CONFIGURATION OF UPLINK HYBRID AUTOMATIC REPEAT REQUEST PROCESSES AND PROCESS TYPES,” filed Aug. 5, 2020, assigned to the assignee hereof, and expressly incorporated herein by reference in its entirety.

### INTRODUCTION

Various aspects described herein generally relate to wireless communications, and more particularly to configuration of uplink hybrid automatic repeat requests (HARQ).

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. It is desirable to support several hundreds of thousands of simultaneous connections in order to support deployments having a large number of connected devices. Consequently, one aim is to significantly enhance the spectral efficiency of 5G mobile communications. Another aim is to enhance signaling efficiencies and substantially reduce latency.

### SUMMARY

This summary identifies features of some example aspects, and is not an exclusive or exhaustive description of the disclosed subject matter. Whether features or aspects are included in or omitted from this summary is not intended as indicative of relative importance of such features. Additional features and aspects are described and will become apparent to persons skilled in the art upon reading the following detailed description and viewing the drawings that form a part thereof.

An aspect directed to a method of communication performed by a user equipment (UE) is disclosed. The method may comprise receiving, from a network node, an uplink (UL) grant for a physical uplink shared channel (PUSCH) associated with a hybrid automatic repeat request (HARQ) process. The method may also comprise transmitting, to the network node, an UL message on the PUSCH using a transmit configuration in accordance with the associated HARQ process. The transmit configuration may be one of a plurality of transmit configurations. At least two of the plurality of transmit configurations may be configured for different HARQ processes.

An aspect directed to a user equipment (UE) is disclosed. The user equipment may comprise means for receiving, from a network node, an uplink (UL) grant for a physical uplink shared channel (PUSCH) associated with a hybrid automatic repeat request (HARQ) process. The user equipment also may comprise means for transmitting, to the network node, an UL message on the PUSCH using a transmit configuration in accordance with the associated HARQ process. The transmit configuration may be one of a plurality of transmit configurations. At least two of the plurality of transmit configurations may be configured for different HARQ processes.

An aspect directed to a user equipment (UE) is disclosed. The user equipment may comprise a memory and at least one processor coupled to the memory. The memory and the at least one processor may be configured to receive, from a network node, an uplink (UL) grant for a physical uplink shared channel (PUSCH) associated with a hybrid automatic repeat request (HARQ) process. The memory and the at least one processor may be configured to transmit, to the network node, an UL message on the PUSCH using a transmit configuration in accordance with the associated HARQ process. The transmit configuration may be one of a plurality of transmit configurations. At least two of the plurality of transmit configurations may be configured for different HARQ processes.

An aspect directed non-transitory computer-readable medium storing computer-executable instructions for a user equipment (UE) is disclosed. The computer-executable instruction may comprise one or more instruction that cause the UE to receive, from a network node, an uplink (UL) grant for a physical uplink shared channel (PUSCH) associated with a hybrid automatic repeat request (HARQ) process. The computer-executable instruction may comprise one or more instruction that cause the UE to transmit, to the network node, an UL message on the PUSCH using a transmit configuration in accordance with the associated HARQ process. The transmit configuration may be one of a plurality of transmit configurations. At least two of the plurality of transmit configurations may be configured for different HARQ processes.

An aspect directed to a method of communication performed by a network node is disclosed. The method may comprise sending, to a user equipment (UE), an uplink (UL) grant for a physical uplink shared channel (PUSCH) associated with a hybrid automatic repeat request (HARQ) process. The method may also comprise receiving, from the UE, an UL message on the PUSCH using a transmit configuration in accordance with the associated HARQ process. The transmit configuration may be one of a plurality of transmit configurations. At least two of the plurality of transmit configurations may be different from each other.

An aspect directed to a network node is disclosed. The network node may comprise means for sending, to a user equipment (UE), an uplink (UL) grant for a physical uplink shared channel (PUSCH) associated with a hybrid automatic repeat request (HARQ) process. The network node may also comprise means for receiving, from the UE, an UL message on the PUSCH using a transmit configuration in accordance with the associated HARQ process. The transmit configuration may be one of a plurality of transmit configurations. At least two of the plurality of transmit configurations may be different from each other.

An aspect directed to a network node is disclosed. The network node may comprise a memory and at least one processor coupled to the memory. The memory and the at least one processor may be configured to send, to a user equipment (UE), an uplink (UL) grant for a physical uplink shared channel (PUSCH) associated with a hybrid automatic repeat request (HARQ) process. The memory and the at least one processor may also be configured to receive, from the UE, an UL message on the PUSCH using a transmit configuration in accordance with the associated HARQ process. The transmit configuration may be one of a plurality of transmit configurations. At least two of the plurality of transmit configurations may be different from each other.

An aspect directed non-transitory computer-readable medium storing computer-executable instructions for a network node is disclosed. The computer-executable instruction may comprise one or more instruction that cause the network node to send, to a user equipment (UE), an uplink (UL) grant for a physical uplink shared channel (PUSCH) associated with a hybrid automatic repeat request (HARQ) process. The computer-executable instruction may also comprise one or more instruction that cause the network node to receive, from the UE, an UL message on the PUSCH using a transmit configuration in accordance with the associated HARQ process. The transmit configuration may be one of a plurality of transmit configurations. At least two of the plurality of transmit configurations may be different from each other.

An aspect directed to a method of communication performed by a user equipment (UE) is disclosed. The method may comprise receiving, from a network node, an uplink (UL) grant for a physical uplink shared channel (PUSCH) for a hybrid automatic repeat request (HARQ) process. The method may also comprise receiving, from the network node contemporaneously with the UL grant for the PUSCH, a transmit configuration indicator indicating a transmit configuration of a plurality of transmit configurations to be associated with the HARQ process. The method may further comprise transmitting, to the network node, an UL message on the PUSCH using the indicated transmit configuration.

An aspect directed to a user equipment (UE) is disclosed. The user equipment may comprise means for receiving, from a network node, an uplink (UL) grant for a physical uplink shared channel (PUSCH) for a hybrid automatic repeat request (HARQ) process. The user equipment may also comprise means for receiving, from the network node, contemporaneously with the UL grant for the PUSCH, a transmit configuration indicator indicating a transmit configuration of a plurality of transmit configurations to be associated with the HARQ process. The user equipment may further comprise means for transmitting, to the network node, an UL message on the PUSCH using the indicated transmit configuration.

An aspect directed to a user equipment (UE) is disclosed. The user equipment may comprise a memory and at least one processor coupled to the memory. The memory and the at least one processor may be configured to receive, from a network node, an uplink (UL) grant for a physical uplink shared channel (PUSCH) for a hybrid automatic repeat request (HARQ) process. The memory and the at least one processor may also be configured to receive, from the network node, contemporaneously with the UL grant for the PUSCH, a transmit configuration indicator indicating a transmit configuration of a plurality of transmit configurations to be associated with the HARQ process. The memory and the at least one processor may further be configured to transmit, to the network node, an UL message on the PUSCH using the indicated transmit configuration.

An aspect directed non-transitory computer-readable medium storing computer-executable instructions for a user equipment (UE) is disclosed. The computer-executable instruction may comprise one or more instruction that cause the UE to receive, from a network node, an uplink (UL) grant for a physical uplink shared channel (PUSCH) for a hybrid automatic repeat request (HARQ) process. The computer-executable instruction may also comprise one or more instruction that cause the UE to receive, from the network node contemporaneously with the UL grant for the PUSCH, a transmit configuration indicator indicating a transmit configuration of a plurality of transmit configurations to be associated with the HARQ process. The computer-executable instruction may further comprise one or more instruction that cause the UE to transmit, to the network node, an UL message on the PUSCH using the indicated transmit configuration.

An aspect directed to a method of communication performed by a network node is disclosed. The method may comprise sending, to a user equipment (UE), an uplink (UL) grant for a physical uplink shared channel (PUSCH) for a hybrid automatic repeat request (HARQ) process. The method may also comprise sending, to the UE, contemporaneously with the UL grant for the PUSCH, a transmit configuration indicator indicating which of a plurality of transmit configurations is to be associated with the HARQ process. The method may further comprise receiving, from the UE, an UL message on the PUSCH using the indicated transmit configuration.

An aspect directed to a network node is disclosed. The network node may comprise means for sending, to a user equipment (UE), an uplink (UL) grant for a physical uplink shared channel (PUSCH) for a hybrid automatic repeat request (HARQ) process. The network node may also comprise means for sending, to the UE contemporaneously with the UL grant for the PUSCH, a transmit configuration indicator indicating which of a plurality of transmit configurations is to be associated with the HARQ process. The network node may further comprise means for receiving, from the UE, an UL message on the PUSCH using the indicated transmit configuration.

An aspect directed to a network node is disclosed. The network node may comprise a memory and at least one processor coupled to the memory. The memory and the at least one processor may be configured to send, to a user equipment (UE), an uplink (UL) grant for a physical uplink shared channel (PUSCH) for a hybrid automatic repeat request (HARQ) process. The memory and the at least one processor may also be configured to send, to the UE contemporaneously with the UL grant for the PUSCH, a transmit configuration indicator indicating which of a plurality of transmit configurations is to be associated with the HARQ process. The memory and the at least one processor may further be configured to receive, from the UE, an UL message on the PUSCH using the indicated transmit configuration.

An aspect directed non-transitory computer-readable medium storing computer-executable instructions for a network node is disclosed. The computer-executable instruction may comprise one or more instruction that cause the network node to send, to a user equipment (UE), an uplink (UL) grant for a physical uplink shared channel (PUSCH) for a hybrid automatic repeat request (HARQ) process. The computer-executable instruction may also comprise one or more instruction that cause the network node to send, to the UE, contemporaneously with the UL grant for the PUSCH, a transmit configuration indicator indicating which of a plurality of transmit configurations is to be associated with the HARQ process. The computer-executable instruction may further comprise one or more instruction that cause the network node to receive, from the UE, an UL message on the PUSCH using the indicated transmit configuration.

An aspect directed to a method of communication performed by a user equipment (UE) is disclosed. The method may comprise receiving, from a network node, an uplink (UL) grant for a physical uplink shared channel (PUSCH) associated with a hybrid automatic repeat request (HARQ) process. The method may also comprise applying a transmit configuration to the PUSCH in accordance with the associated HARQ process. The applied transmit configuration may be one of a plurality of transmit configurations. Each of the plurality of transmit configurations may be associated with a HARQ process. At least two of the plurality of transmit configurations may be different from each other. The method may further comprise transmitting, to the network node, an UL message on the PUSCH.

An aspect directed to a user equipment (UE) is disclosed. The user equipment may comprise means for receiving, from a network node, an uplink (UL) grant for a physical uplink shared channel (PUSCH) associated with a hybrid automatic repeat request (HARQ) process. The user equipment may also comprise means for applying a transmit configuration to the PUSCH in accordance with the associated HARQ process. The applied transmit configuration may be one of a plurality of transmit configurations. Each of the plurality of transmit configurations may be associated with a HARQ process. At least two of the plurality of transmit configurations may be different from each other. The user equipment may further comprise means for transmitting, to the network node, an UL message on the PUSCH.

An aspect directed to a user equipment (UE) is disclosed. The user equipment may comprise a memory and at least one processor coupled to the memory. The memory and the at least one processor may be configured to receive, from a network node, an uplink (UL) grant for a physical uplink shared channel (PUSCH) associated with a hybrid automatic repeat request (HARQ) process. The memory and the at least one processor may also be configured to apply a transmit configuration to the PUSCH in accordance with the associated HARQ process. The applied transmit configuration may be one of a plurality of transmit configurations. Each of the plurality of transmit configurations may be associated with a HARQ process. At least two of the plurality of transmit configurations may be different from each other. The memory and the at least one processor may further be configured to transmit, to the network node, an UL message on the PUSCH.

An aspect directed non-transitory computer-readable medium storing computer-executable instructions for a user equipment (UE) is disclosed. The computer-executable instruction may comprise one or more instruction that cause the UE to receive, from a network node, an uplink (UL) grant for a physical uplink shared channel (PUSCH) associated with a hybrid automatic repeat request (HARQ) process. The computer-executable instruction may also comprise one or more instruction that cause the UE to apply a transmit configuration to the PUSCH in accordance with the associated HARQ process. The applied transmit configuration may be one of a plurality of transmit configurations. Each of the plurality of transmit configurations may be associated with a HARQ process. At least two of the plurality of transmit configurations may be different from each other. The computer-executable instruction may further comprise one or more instruction that cause the UE to transmit, to the network node, an UL message on the PUSCH.

An aspect directed to a method of communication performed by a network node is disclosed. The method may comprise sending, to a user equipment (UE), an uplink (UL) grant for a physical uplink shared channel (PUSCH) associated with a hybrid automatic repeat request (HARQ) process. The method may also comprise receiving, from the UE, an UL message on the PUSCH. A transmit configuration may be applied to the PUSCH in accordance with the associated HARQ process. The applied transmit configuration may be one of a plurality of transmit configurations. Each of the plurality of transmit configurations may be associated with a HARQ process. At least two of the plurality of transmit configurations may be different from each other.

An aspect directed to a network node is disclosed. The network node may comprise means for sending, to a user equipment (UE), an uplink (UL) grant for a physical uplink shared channel (PUSCH) associated with a hybrid automatic repeat request (HARQ) process. The network node may also comprise means for receiving, from the UE, an UL message on the PUSCH. A transmit configuration may be applied to the PUSCH in accordance with the associated HARQ process. The applied transmit configuration may be one of a plurality of transmit configurations. Each of the plurality of transmit configurations may be associated with a HARQ process. At least two of the plurality of transmit configurations may be different from each other.

An aspect directed to a network node is disclosed. The network node may comprise a memory and at least one processor coupled to the memory. The memory and the at least one processor may be configured to send, to a user equipment (UE), an uplink (UL) grant for a physical uplink shared channel (PUSCH) associated with a hybrid automatic repeat request (HARQ) process. The memory and the at least one processor may also be configured to receive, from the UE, an UL message on the PUSCH. A transmit configuration may be applied to the PUSCH in accordance with the associated HARQ process. The applied transmit configuration may be one of a plurality of transmit configurations. Each of the plurality of transmit configurations may be associated with a HARQ process. At least two of the plurality of transmit configurations may be different from each other.

An aspect directed non-transitory computer-readable medium storing computer-executable instructions for a network node is disclosed. The computer-executable instruction may comprise one or more instruction that cause the network node to send, to a user equipment (UE), an uplink (UL) grant for a physical uplink shared channel (PUSCH) associated with a hybrid automatic repeat request (HARQ) process. The computer-executable instruction may also comprise one or more instruction that cause the network node to receive, from the UE, an UL message on the PUSCH. A transmit configuration may be applied to the PUSCH in accordance with the associated HARQ process. The applied transmit configuration may be one of a plurality of transmit configurations. Each of the plurality of transmit configurations may be associated with a HARQ process. At least two of the plurality of transmit configurations may be different from each other.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of examples of one or more aspects of the disclosed subject matter and are provided solely for illustration of the examples and not limitation thereof:

FIG. 1 illustrates an exemplary wireless communications system, according to various aspects;

FIG. 2 illustrates an exemplary network node in communication with an exemplary user equipment, according to various aspects;

FIG. 3 illustrates an example signaling between a network node and a user equipment, according to various aspects;

FIGS. 4A and 4B illustrate flow charts of exemplary methods performed by a user equipment to transmit uplink messages, according to various aspects;

FIGS. 5A and 5B illustrate flow charts of exemplary processes performed by a network node to enable a user equipment to transmit uplink messages, according to various aspects;

FIG. 6 illustrates another example signaling between a network node and a user equipment, according to various aspects;

FIGS. 7A and 7B illustrate flow charts of further exemplary methods performed by a user equipment to transmit uplink messages, according to various aspects;

FIGS. 8A and 8B illustrate flow charts of further exemplary processes performed by a network node to enable a user equipment to transmit uplink messages, according to various aspects;

FIG. 9 illustrates a simplified block diagram of an example user equipment, according to various aspects; and

FIG. 10 illustrates a simplified block diagram of an example network node, according to various aspects.

### DETAILED DESCRIPTION

Various aspects described herein generally relate to hybrid automatic repeat request (HARQ) feedbacks in networks with large propagation delays. An example of a network with large propagation delay is a non-terrestrial network (NTN). Examples of NTNs include networks based on satellites, balloons, aircrafts, unmanned aerial vehicles, etc., which may be categorized into high altitude platform station (HAPS) and satellites. In one or more aspects, a satellite-based NTN may comprise one or more low earth orbit (LEO) and/or one or more medium earth orbit (MEO) satellites. In terrestrial networks (e.g., 5G New Radio (NR), LTE, etc.), HARQ processes with feedbacks and retransmissions may enable messages to be transmitted reliably between base stations (e.g., gNB, eNB, etc.) and user equipments (UEs).

However, in some networks, there can be large propagation delays due to the distances involved between network nodes and UEs (e.g., between satellites and UEs). To improve upon large round-trip delays, in one or more examples, HARQ uplink (UL) retransmissions at the UE transmitter can be disabled.

According to one or more aspects, even if HARQ UL retransmissions are disabled, other aspects of the HARQ processes may still be configured. For example, transmit parameters such as power control, modulation and coding scheme (MCS), etc. (more on this below) may be configured. The enabling or disabling of HARQ uplink retransmission can be configured on a per UE basis, per HARQ process basis, and/or per logical channel (LCH) basis.

Depending on the configuration, there can be different challenges and it would be desirable to configure the uplink transmission including HARQ processes to mitigate the issues. For example, if retransmission is disabled (e.g., due to the large delay), then recovery from initial transmission errors would not be possible. Thus, it may be desirable to make the initial transmission as reliable as possible, e.g., by setting the block error rate (BLER) as low as practicable. On the other hand, if retransmission is enabled (e.g., if the delay is tolerable), then even with a relatively high BLER, high end-to-end reliability can be achieved since information can be retransmitted.

Since the HARQ processes are configurable, it is proposed also to configure, apply, use or otherwise associate one or more transmit configurations to one or more HARQ processes (not necessarily one-to-one) for uplink transmissions from a UE to a network. In one or more aspects, the transmit configurations may be individualized on a per HARQ process basis. For example, a transmit configuration may be associated with a HARQ process, and the same or a different transmit configuration may be associated with another HARQ process. Alternatively, or in addition thereto, transmit configurations may be associated on a HARQ process type basis. For example, a transmit configuration may be associated with a HARQ process of one HARQ process type, and the same or a different transmit configuration may be associated with a HARQ process of another HARQ process type.

There can be a plurality of HARQ process (e.g., 16). Alternatively, or in addition thereto, there may be a plurality of HARQ process types. For example, a HARQ process of one HARQ process type (e.g., a first HARQ process type) may have retransmission enabled, and a HARQ process of another HARQ process type (e.g., a second HARQ process type) may have retransmission disabled. HARQ processes and HARQ process types will be further described below.

According to one example, a network node may provide an uplink grant to the UE for uplink channel (e.g., physical uplink shared channel (PUSCH)) resources associated with a HARQ process and/or with a HARQ process type. The UE may use a transmit configuration to the uplink channel in accordance with the associated HARQ process. The UE may transmit an uplink message (e.g., uplink shared channel (UL-SCH) data, UCI, MAC CE, etc.) on the uplink channel. In one example, the transmit configuration of the uplink channel may be matched to the requirements of the uplink message. For example, for the uplink message to be delivered to the network reliably, transmission parameters such as power control, demodulation reference signal (DMRS) pattern, modulation and control scheme (MCS), etc. of the transmit configuration may be set accordingly to meet the reliability requirements of the uplink message. In doing so, delivery requirements of the uplink message may be provided with proper matching shared channel resources.

The associations between the transmit configurations and the HARQ processes and/or the

HARQ process types may be explicit or implicit. In an explicit association, the association between a transmit configuration with a HARQ process or with a HARQ process type is known to the UE independent of any uplink channel resources for the HARQ process being scheduled. If uplink channel resources are scheduled for a HARQ process, this may be sufficient for the UE to determine the transmit configuration to be used with the HARQ process from the known association between the HARQ process and the transmit configuration and/or between the HARQ process type of the HARQ process and the transmit configuration. The network does not need to inform the UE to use a particular transmit configuration on the scheduled uplink channel resources for the HARQ process when the uplink channel resources are scheduled.

For example, if a HARQ process is explicitly associated with a transmit configuration, then when uplink channel resources are scheduled for the HARQ process, the UE may determine that the transmit configuration to be used is the transmit configuration associated with the HARQ process, without being informed by the network to use the associated transmit configuration. In other words, scheduling of the uplink channel resources for the HARQ process may be sufficient for the UE to determine the transmit configuration to be used for the HARQ process due to the explicit association between the transmit configuration and the HARQ process type. Similarly, if a HARQ process type is explicitly associated with a transmit configuration, then when uplink channel resources are scheduled for a HARQ process of that HARQ process type, the UE may determine that the transmit configuration to be used is the transmit configuration associated with the HARQ process type of the HARQ process, without being informed by the network to use the associated transmit configuration. In other words, scheduling of the uplink channel resources for the HARQ process may be sufficient for the UE to determine the transmit configuration to be used for the HARQ process due to the explicit association between the transmit configuration and the HARQ process type of the HARQ process. The explicit associations may be configured within the UE statically (e.g., factory setting) and/or by the network (e.g., through radio resource control (RRC) messages).

On the other hand, in an implicit association, the association between a transmit configuration with a HARQ process or with a HARQ process type may established when the uplink channel resources for the HARQ process are scheduled for the UE. That is, the association may not be independent of the uplink channel resources for the HARQ process being scheduled for the UE. In one aspect, a HARQ process or a HARQ process type may not be explicitly associated with any transmit configuration. Therefore, when uplink resources for the HARQ process are scheduled, the UE may also be notified of the transmit configuration to be used. In another aspect, there may be an existing association between a HARQ process or a HARQ process type and a transmit configuration, but the network may wish to override the existing association, at least for these scheduled uplink channel resources.

For implicit associations, when the network schedules uplink channel resources for the UE, the network may also contemporaneously indicate associations between the HARQ process and/or the HARQ process types of the scheduled uplink channel resources. For example, if the association is for a HARQ process, then the UE may use the indicated transmit configuration on the scheduled uplink resources for the HARQ process. If the association is with a HARQ process type, then the UE may use the indicated transmit configuration on the scheduled uplink resources for a HARQ process of the HARQ process type.

As noted, in implicit associations, the network may inform the UE of the uplink channel resources scheduled for the UE as well as informing the associations between HARQ processes or HARQ process types and the transmit configurations pertaining to the scheduled uplink resources. Since the uplink channel resources and the transmit configurations to be used are tied, it may be desirable for the UE to informed of the scheduled uplink channel resources and the associations contemporaneously. For example, the UE may be informed of both in a same downlink control information (DCI) message from the network. In another example, the UE may be informed of the associations in a message (e.g., MAC CE) just prior to receiving the uplink channel resources scheduling information.

These and other aspects are provided in the following description and related drawings directed to specific examples of the disclosed subject matter. Alternates may be devised without departing from the scope of the disclosed subject matter. Additionally, well-known elements will not be described in detail or will be omitted so as not to obscure the relevant details.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

The terminology used herein describes particular aspects only and should not be construed to limit any aspects disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be stored entirely within any form of non-transitory computer-readable medium having stored thereon a corresponding set of computer instructions that upon execution would cause an associated processor to perform the functionality described herein. Thus, the various aspects described herein may be implemented in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the terms “user equipment” (UE), “user terminal” (UT), and “base station” are not intended to be specific or otherwise limited to any particular Radio Access Technology (RAT), unless otherwise noted. In general, such UEs, interchangeable with UTs, may be any wireless communication device (e.g., a mobile phone, router, tablet computer, laptop computer, tracking device, Internet of Things (IoT) device, etc.) used by a user to communicate over a wireless communications network. A UE/UT may be mobile or may (e.g., at certain times) be stationary, and may communicate with a Radio Access Network (RAN). As used herein, the interchangeable terms “UE” and “UT”, may also be referred to interchangeably as an “access terminal” or “AT,” a “client device,” a “wireless device,” a “subscriber device,” a “subscriber terminal,” a “subscriber station,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an Access Point (AP), a Network Node, a NodeB, an evolved NodeB (eNB), a general Node B (gNodeB, gNB), etc. In addition, in some systems a base station may provide purely edge node signaling functions while in other systems it may provide additional control and/or network management functions.

UEs can be implemented by any of a number of types of devices including but not limited to printed circuit (PC) cards, compact flash devices, external or internal modems, wireless or wireline phones, smartphones, tablets, tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

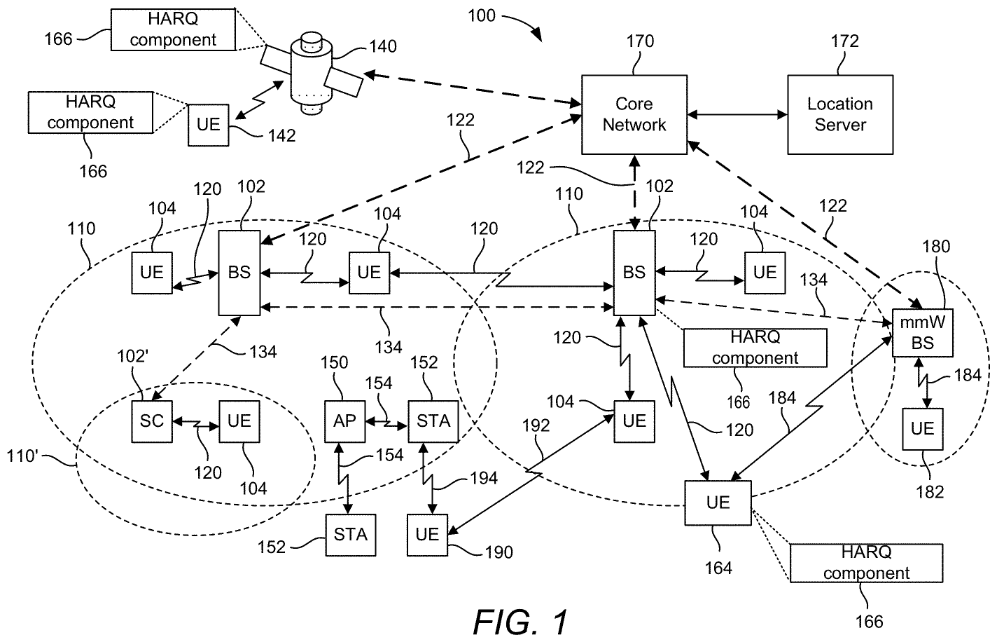

According to various aspects, FIG. 1 illustrates an exemplary wireless communications system 100. The wireless communications system 100 (which may also be referred to as a wireless wide area network (WWAN)) may include various base stations 102 and various UEs 104. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency.

In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may also include a satellite 140 in communication with a UE 142. The satellite 140 may behave as a network node (e.g., a base station) to the UE 142. The satellite 140 may be a low earth orbit (MEO), a medium earth orbit (MEO), or even a geosynchronous satellite.

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies in communication with a UE 182. The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Communications using the mmW radio frequency band have high path loss and a relatively short range. The mmW base station 180 and the UE 182 may therefore utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing a radio frequency (RF) signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while canceling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive one or more reference downlink reference signals (e.g., positioning reference signals (PRS), tracking reference signals (TRS), phase tracking reference signal (PTRS), cell-specific reference signals (CRS), channel state information reference signals (CSI-RS), primary synchronization signals (PSS), secondary synchronization signals (SSS), synchronization signal blocks (SSBs), etc.) from a base station. The UE can then form a transmit beam for sending one or more uplink reference signals (e.g., uplink positioning reference signals (UL-PRS), sounding reference signal (SRS), demodulation reference signals (DMRS), PTRS, etc.) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

5G supports multi-carrier operation, such as carrier aggregation. In a multi-carrier system, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164. In an aspect, the UE 164 may include a HARQ component 166 that may enable the UE 164 to perform the UE HARQ operations described herein. Similarly, the base stations 102 may include a HARQ component 166 that may enable the base stations 102 to perform the base station HARQ operations described herein. Note that although only UE 164 and one base station 102 in FIG. 1 are illustrated as including a HARQ component 166, any of the UEs and base stations in FIG. 1, including the satellite 140, may include a HARQ component 166.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

5G uses RF signals at mmW frequencies for wireless communication between network nodes, such as base stations, UEs, vehicles, factory automation machinery, and the like. However, mmW RF signals can be used for other purposes as well, such as weapons systems (e.g., as short-range fire-control radar in tanks and aircraft), security screening systems (e.g., in scanners that detect weapons and other dangerous objects carried under clothing), medicine (e.g., to treat disease by changing cell growth), and the like. In addition, mmW RF signals can be used for environmental sensing, such as object detection and motion sensing.

RF signals at mmW frequencies can provide high bandwidth and a large aperture to extract accurate range, Doppler, and angle information for environment sensing. Using mmW RF signals for environment sensing can provide such features in a compact form factor, such as a small sensing component that can conveniently fit into a handheld device. Such a sensing component (e.g., chip) may be a digital signal processor (DSP), system-on-chip (SoC), or other processing component that can be integrated into another device (a host device), such as a UE, a base station, an IoT device, a factory automation machine, or the like. In an aspect, a sensing component may be, or may be incorporated into, a modem for wireless communication, such as a 5G modem, a 60 GHz WLAN modem, or the like. A device containing a sensing component may be referred to as a host device, an environment sensing device, a sensing device, and the like.

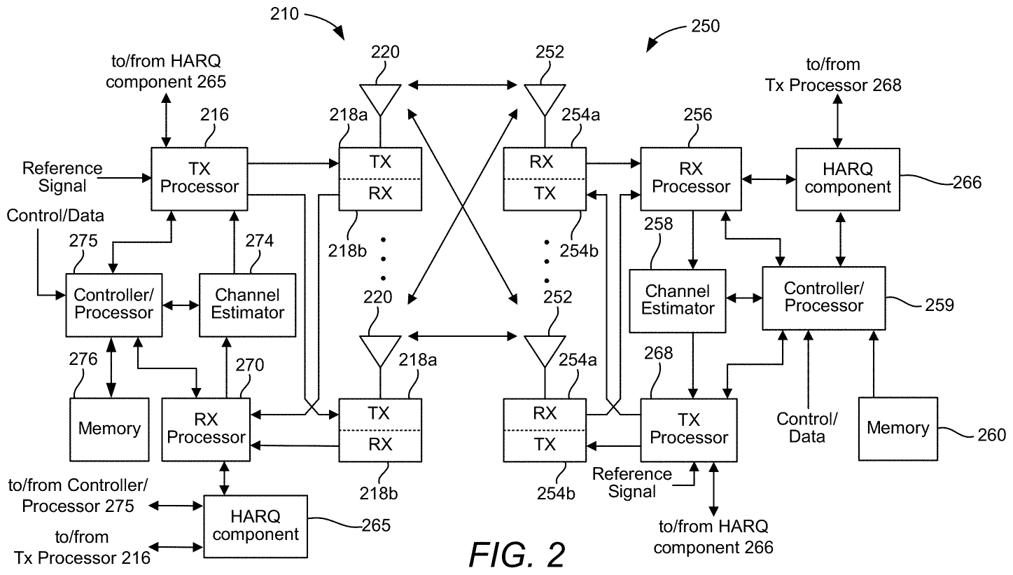

According to various aspects, FIG. 2 illustrates an exemplary network node 210 (e.g., non-terrestrial network (NTN) node) in communication with an exemplary UE 250. Internet Protocol (IP) packets may be provided to a controller/processor 275. The controller/processor 275 may implement functionality for a radio resource control (RRC) layer, a packet data convergence protocol (PDCP) layer, a radio link control (RLC) layer, and a medium access control (MAC) layer. The controller/processor 275 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT (radio access technology) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through automatic repeat requests (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmit (TX) processor 216 and the receive (RX) processor 270 may implement Layer-1 functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and multiple-input and multiple-output (MIMO) antenna processing. The TX processor 216 may handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to one or more different antennas 220 via a separate transmitter 218a. Each transmitter 218a may modulate an RF carrier with a respective spatial stream for transmission.

At the UE 250, each receiver 254a may receive a signal through its respective antenna 252. Each receiver 254a may recover information modulated onto an RF carrier and may provide the information to the RX processor 256. The TX processor 268 and the RX processor 256 may implement Layer-1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 may then convert the OFDM symbol stream from the time-domain to the frequency domain using a Fast Fourier Transform (FFT). The frequency domain signal may comprise a separate OFDM symbol stream for each subcarrier of the OFDM signal. The symbols on each subcarrier, and the reference signal, may be recovered and demodulated by determining the most likely signal constellation points transmitted by the network node 210. These soft decisions may be based on channel estimates computed by the channel estimator 258. The soft decisions may then be decoded and de-interleaved to recover the data and control signals that were originally transmitted by the network node 210 on the physical channel. The data and control signals may then be provided to the controller/processor 259, which implements Layer-3 and Layer-2 functionality.

The controller/processor 259 can be associated with a memory 260 that stores program codes and data. The memory 260 may be referred to as a computer-readable medium. In the UL, the controller/processor 259 may provide demultiplexing between transport and logical channels, packet reassembly, deciphering, header decompression, and control signal processing to recover IP packets from the core network. The controller/processor 259 may also be responsible for error detection.

Similar to the functionality described in connection with the transmission by the network node 210, the controller/processor 259 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TB), demultiplexing of MAC SDUs from TBs, scheduling information reporting, error correction through HARQ, priority handling, and logical channel prioritization.

Channel estimates derived by the channel estimator 258 from a reference signal or feedback transmitted by the network node 210 may be used by the TX processor 268 to select the appropriate coding and modulation schemes, and to facilitate spatial processing. The spatial streams generated by the TX processor 268 may be provided to different antenna 252 via separate transmitters 254b. Each transmitter 254b may modulate an RF carrier with a respective spatial stream for transmission.

The UL transmission may be processed at the network node 210 in a manner similar to that described in connection with the receiver function at the UE 250. Each receiver 218b may receive a signal through its respective antenna 220. Each receiver 218b may recover information modulated onto an RF carrier and may provide the information to a RX processor 270.

The controller/processor 275 can be associated with a memory 276 that stores program codes and data. The memory 276 may be referred to as a computer-readable medium. In the UL, the controller/processor 275 may provide demultiplexing between transport and logical channels, packet reassembly, deciphering, header decompression, control signal processing to recover IP packets from the UE 250. IP packets from the controller/processor 275 may be provided to the core network. The controller/processor 275 may also be responsible for error detection.

In the UE 250, the transmitter 254b and the receiver 254a may together form a transceiver 254. In the network node 210, the transmitter 218a and the receiver 218b may together form a transceiver 218.

The network node 210 may include a HARQ component 265 configured to perform network node HARQ processes described herein. Also, the UE 250 may include a HARQ component 266 configured to perform UE HARQ processes described herein. The network node 210 and the UE 250 may be configured to implement the proposed approach for configuring of uplink HARQ processes and/or HARQ process types. While uplink transmissions will be discussed in detail, it is contemplated that the discussed approach may be adapted to downlink transmissions.

There may be N (e.g., 16) of HARQ processes configured for the UE for UL transmission. Also, there may be M HARQ process types. In one example, HARQ process type may be based on whether HARQ retransmission is enabled or disabled. For ease of reference, a HARQ process that has the retransmission enabled may be referred to as a HARQ process of a first HARQ process type, and a HARQ process that has the retransmission disabled may be referred to as a HARQ process of a second HARQ process type. When HARQ processes are typed based on a status of the HARQ retransmission (e.g., enabled or disabled), then M=2. This is one way of typing the HARQ processes, but is not necessarily the only way. Thus, the number M will depend on the approach to typing the HARQ processes. In general, each of the N HARQ processes may be defined as being one of M HARQ process types.

As indicated above, it is proposed also to configure, apply, use or otherwise associate one or more transmit configurations for one or more HARQ processes for uplink transmissions from a UE to a network. The transmit configurations may be individualized on per HARQ process basis. For example, a HARQ process may be associated with a transmit configuration, and another HARQ process may be associated with the same or a different transmit configuration. In this instance, the number of transmit configurations can be up to N (e.g., when each HARQ process is associated with a different transmit configuration) or less.

The transmit configurations may be on per HARQ process type basis. For example, a HARQ process of one HARQ process type may be associated with a transmit configuration, and a HARQ process of another HARQ process type may be associated the same or a different transmit configuration. In this instance, the number of transmit configurations can be up to M (e.g., when each HARQ process type is associated with a different transmit configuration) or less. It is also contemplated that there can be a mixture. That is, one or more HARQ processes may be associated with the transmit configurations on per HARQ process basis and one or more other HARQ processes associated with the transmit configurations on per HARQ process type basis.

In general, there may be a plurality of transmit configurations, and each transmit configuration may be associated with (e.g., mapped to) a HARQ process and/or to a HARQ process type. In an aspect, the UE may be statically configured (e.g., factory set) with a plurality of default transmit configurations and their associations with HARQ processes and or HARQ process types. Alternatively, or in addition thereto, the network (e.g., network node) may configure the UE with one or more transmit configurations and/or specify their associations with the HARQ processes and/or HARQ process types, e.g., in an RRC message. In an aspect, the specified association may take precedence over, i.e., override, a previously existing association. For example, a HARQ process (or a HARQ process type) may currently be associated with a transmit configuration. Then if the network node so specifies, the HARQ process (or the HARQ process type) may be associated with a different transmit configuration.

In operation, a network node (e.g., NTN node) may provide, to a UE, an UL grant for UL channel (e.g., PUSCH) resources. The grant may be for one or more HARQ process types. That is, some resources of the granted PUSCH may be associated with one HARQ process type, and some other resources of the granted PUSCH may be associated with another HARQ process type. In general, the granted PUSCH may be associated with as few as one HARQ process type. In this instance, the resources of the granted PUSCH for the UE may be used by one or more HARQ processes of the one HARQ process type. In an aspect, when there are multiple HARQ processes of the one HARQ process type, different portions of the granted PUSCH may be associated with each of the multiple HARQ processes. For example, first and second portions of the granted PUSCH may respectively be associated with first and second HARQ processes of a same HARQ process type (e.g., retransmission enabled). In this instance, information carried on the first and second portions of the granted PUSCH may be retransmitted if necessary.

The granted PUSCH may also be associated with as many as M HARQ process types. When the PUSCH is associated with multiple HARQ process types, then different sets of the granted PUSCH resources may be associated with the different HARQ process types. For each set associated with a HARQ process type, one or more HARQ processes of that HARQ process type may use the set of resources of the granted PUSCH. In an aspect, when there are multiple HARQ processes of a HARQ process type, different portions of the set of resources of the granted PUSCH may be associated with each of the multiple HARQ processes. For example, first and second portions of the granted PUSCH may respectively be associated with first and second HARQ processes respectively of first (e.g., retransmission enabled) and second (e.g., retransmission disabled) HARQ process types. In this instance, information carried on the first portion of the granted PUSCH may be retransmitted if necessary. However, information carried on the second portion of the granted PUSCH may not be retransmitted.

Alternatively, or in addition thereto, the UL grant may be for one or more HARQ processes. That is, some resources of the granted PUSCH may be associated with one HARQ process, and some other resources of the granted PUSCH may be associated with another HARQ process. In general, the granted PUSCH may be associated with as few as one HARQ process, in which all of the granted PUSCH for the UE can be for use by the one HARQ process, or as many as N HARQ processes. When the PUSCH is associated with multiple HARQ processes, then different portions of the granted PUSCH resources may be associated with the different HARQ processes.

From the perspective of an individual HARQ process or a HARQ process type, the PUSCH, or at least a portion thereof, may be associated with the HARQ process and/or the HARQ process type. The UE may apply a transmit configuration to the PUSCH in accordance with the associated HARQ process and/or with the associated HARQ process type. The UE may then transmit an uplink message (e.g., any combination of UL-SCH data, UCI, MAC CE, etc.) on the PUSCH.

There may be a plurality of transmit configurations, and each transmit configuration may be associated with (e.g., mapped to) a HARQ process and/or to a HARQ process type. In an aspect, when a transmit configuration is associated with a particular HARQ process type, this implies that the transmit configuration is associated with all HARQ processes of the particular HARQ process type. The UE may apply the transmit configuration to the PUSCH, and then transmit an UL message (e.g., UL-SCH data, UCI, MAC CE, etc.) on the PUSCH.

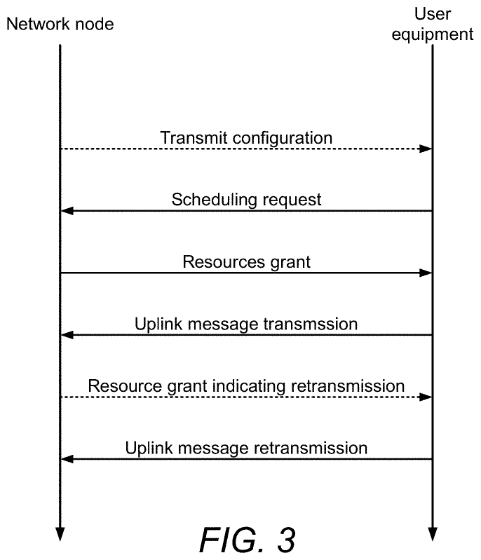

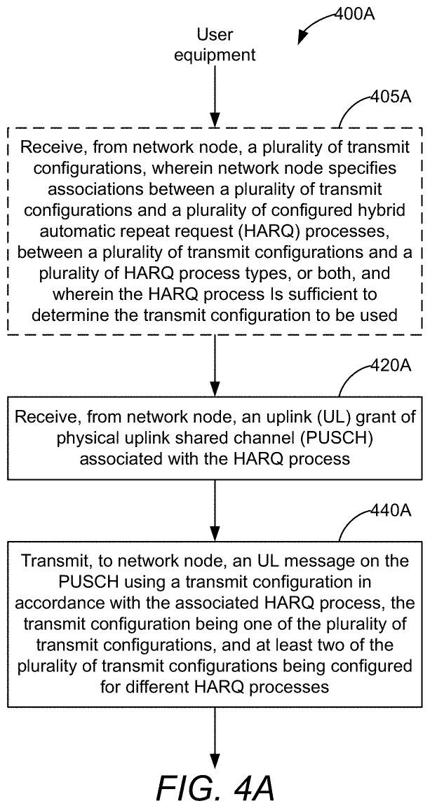

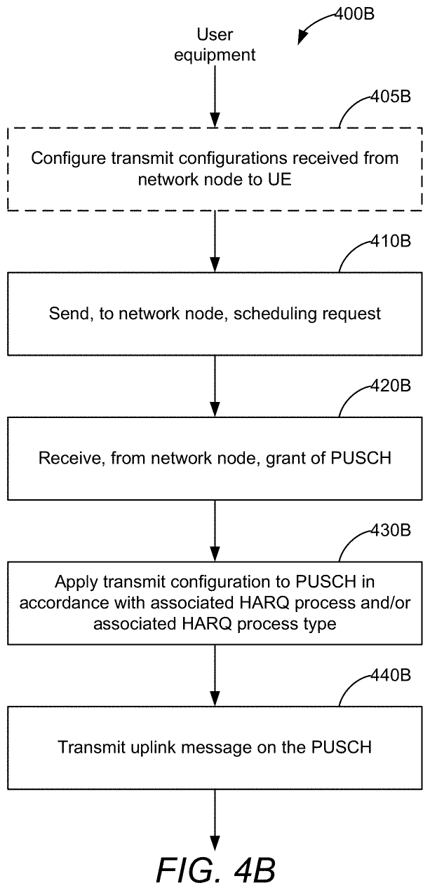

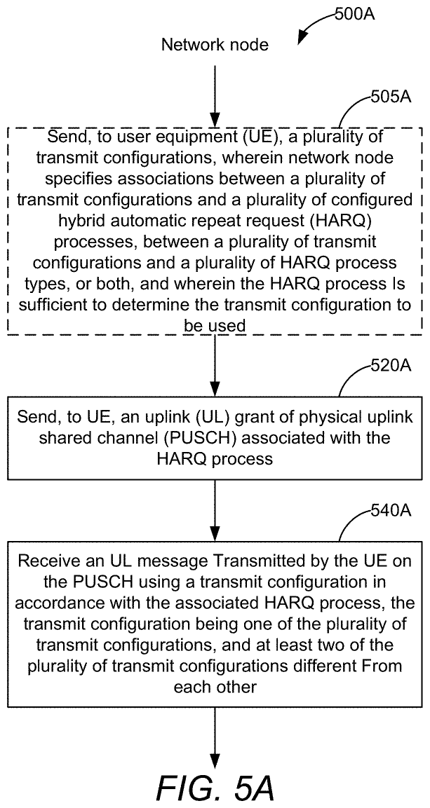

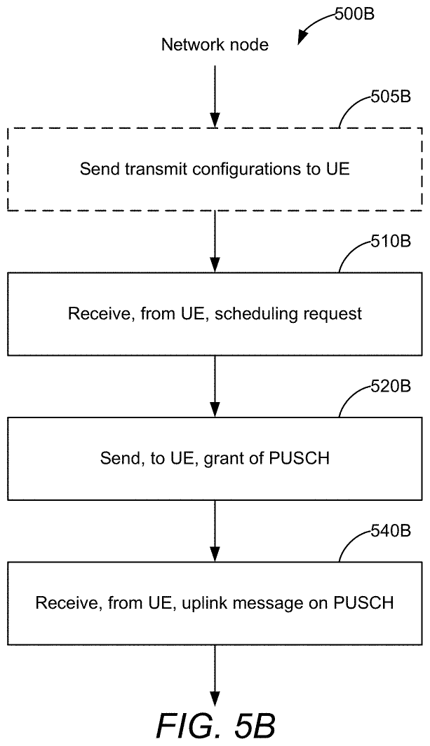

FIG. 3 illustrates an example signaling between the network node and the user equipment. Briefly, the network node may send transmit configuration message to the UE, and the UE may apply the transmit configurations. The UE may send a scheduling request (SR) to the network node when it has uplink messages to send. The network node may grant the UE with uplink (e.g., PUSCH) resources. If HARQ retransmission is enabled, then the UE may retransmit the message if a subsequent grant indicates retransmission (e.g., new data indicator bit is not toggled). Details are provided with respect to FIGS. 4A-5B.

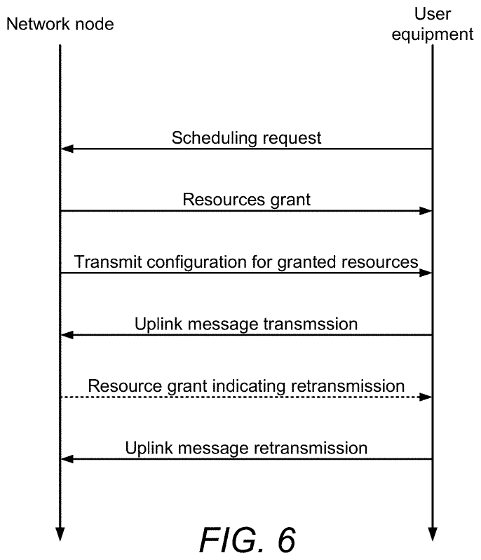

FIG. 3 may be viewed as an example of an explicit association between HARQ processes and transmit configurations and/or between HARQ process types and transmit configurations. When the association is explicit, then scheduling of PUSCH resources of a specific HARQ process and/or HARQ process type may be sufficient for the UE to determine which of the transmit configurations to apply and use in the uplink transmission. Implicit association will be described with respect to FIGS. 6-8B.

FIG. 4A illustrates an exemplary method 400A performed by a UE (e.g., UE 250) to transmit uplink messages. In method 400A, different transmit configurations may be applied and used on different HARQ processes. In this way, adjustments may be made to meet requirements of the uplink message (e.g., speed, reliability, etc.). The memory component 260 may be viewed as an example of a non-transitory computer-readable medium that stores computer-executable instructions to operate components of the UE 250 such as receiver(s) 254a, transmitter(s) 254b, RX processor 256, TX processor 268, controller/processor 259, HARQ component 266, channel estimator 258, etc. to perform the method 400A.

In block 405A, the UE may receive a plurality of transmit configurations from a network node (e.g., network node 210). The transmit configurations may be received through DCI, MAC-CE and/or RRC messages. In an aspect, the network node may specify associations between the plurality of transmit configurations and the plurality of HARQ processes. Alternatively, or in addition thereto, the network node may specify associations between the plurality of transmit configurations and the plurality of HARQ process types. In an aspect, the associations may be specified independent of uplink channel resources actually being scheduled. In this way, each transmit configuration may be associated with a HARQ process and/or a HARQ process type. That is, the associations may be explicit. Thus, the HARQ process by itself may be sufficient to determine the transmit configuration used, e.g., due to the explicit association between HARQ processes and transmit configurations and/or between HARQ process types and transmit configurations. Means for performing block 405A may include antenna(s) 252, receiver(s) 254a, RX processor 256, HARQ component 266, controller/processor 259, memory 260, TX processor 268, and/or transmitter(s) 254b of the UE 250.

In an aspect, one, some, or all of the transmit configurations may each specify any combination of the one or more transmit parameters. Examples of the transmit parameters include power control parameters including a loop index, a modulation and coding scheme (MCS) table, a demodulation reference signal (DMRS) pattern, a time-domain allocation pattern, a frequency hopping pattern, and/or a slot aggregation number.

In another aspect, one, some, or all of the transmit configurations may each specify any combination of the one or more UCI multiplexing parameters for multiplexing UCI and UL-SCH data on the PUSCH. Examples of the UCI multiplexing parameters include beta offsets to indicate one or more resource offsets for different types of UCI, one or more UCI dropping rules, and/or UCI multiplexing priority. The beta offsets may include any one or more a betaOffsetACK, betaOffsetCSI_part1, and/or betaOffsetCSI_part2. The UCI dropping rules may be defined per HARQ process and/or per HARQ process type. The UCI dropping rules may indicate what information, if any, can be dropped.

The UCI multiplexing priority may indicate a priority order of HARQ processes for multiplexing. That is, some HARQ processes may be prioritized to multiplex the UCI over other HARQ processes. For example, if it is important that a particular UCI be delivered reliably to the network node, then HARQ processes with retransmission enabled may be prioritized over HARQ processes with retransmission disabled for transmission of the UCI.

In an aspect, some HARQ processes and/or HARQ process types may be precluded from UCI multiplexing. In this aspect, the UCI multiplexing parameters may also include a UCI multiplex indicator indicating whether UCI multiplexing—multiplexing of UCI and data on the PUSCH—is enabled or disabled. UCI multiplexing is often opportunistic, e.g., when the physical uplink control channel (PUCCH) that configured to carry UCI happens to overlap with PUSCH. Thus, when the UCI multiplexing is enabled, the UCI may be allowed to be multiplexed on the PUSCH.

In an aspect, some HARQ processes and/or HARQ process types may be excluded from UCI only without data. In this aspect, the transmit configuration parameters may also include a UCI only indicator indicating whether a UCI only without UL-SCH data can or cannot be transmitted on the PUSCH.

Note that one or more MAC CEs may also be transmitted on the PUSCH. However, some of them may not be allowed to transmit over HARQ processes of the second HARQ process type (retransmission disabled). For example, Configured Grant Confirmation MAC CE and/or Multiple Entry Configured Grant Confirmation MAC CE may be deemed sufficiently important as to require reliability afforded by retransmissions. For MAC CEs where delivery reliability is not so important, they may be transmitted over HARQ processes of any HARQ process type.

Note that block 405A is dashed to indicate that it is optional. That is, the UE may be statically configured (e.g., factory setting) with transmit configurations and/or their associations with HARQ processes and/or HARQ process types. Indeed, unless otherwise specifically indicated, dashed blocks of flow charts may be understood to be optional. If and when the UE receives the transmit configurations from the network node, the statically configured transmit configurations may be overridden. Also, if block 405A is performed, it is not necessary that the UE receive all of the transmit configurations. For the transmit configurations not received, the previously configured transmit configurations may be utilized.

In block 420A, the UE may receive, from the network node, an uplink grant for PUSCH resources associated with one or more HARQ processes. For example, the UE may receive the grant in a DCI. The granted PUSCH can be associated with one or multiple HARQ processes and/or one or multiple HARQ process types. However, for ease of explanation, perspective of a HARQ process and/or a HARQ process type associated with the PUSCH will be described. It should be understood that the associated HARQ process and/or the associated HARQ process type can respectively be one of a plurality of HARQ processes and/or one of a plurality of HARQ process types supported by the UE. Means for performing block 420A may include antenna(s) 252, receiver(s) 254a, RX processor 256, controller/processor 259, and/or memory 260 of the UE 250.

In block 440A, the UE may transmit an uplink message (any one or more of UL-SCH data, UCI, MAC CE, etc.) to the network node on the PUSCH. The UL message may be transmitted on the PUSCH associated with the HARQ process and/or HARQ process type in accordance with the applied transmit configuration. It may be said that in block 440A, the UE may transmit, to the network node, the UL message on the PUSCH using the transmit configuration in accordance with the associated HARQ process. Different transmit configurations may be associated with different HARQ processes and/or different HARQ process types. To state it another way, for at least two of the plurality of transmit configurations different from each other, they may be configured for two HARQ processes and/or two HARQ process types. For example, the at least two transmit configurations may specify different transmit parameters, different UCI multiplexing parameters, etc. (e.g., see description of block 430B of FIG. 4B below). This is from the perspective of the associated HARQ process and/or the associated HARQ process types. Means for performing block 440A may include antenna(s) 252, HARQ component 266, controller/processor 259, memory 260, TX processor 268, and/or transmitter(s) 254b of the UE 250.

But more broadly, when the granted resources of the PUSCH are associated with multiple HARQ processes and/or with multiple HARQ process types, then for each HARQ process and/or each HARQ process type, the UE may transmit a separate UL message on relevant portions of the PUSCH associated with that HARQ process and/or that HARQ process type.

An UL message that includes the UCI may be transmitted on the PUSCH associated with the HARQ process and/or the HARQ process type. The applied transmit configuration may specify one or more UCI multiplexing parameters for multiplexing UCI and UL-SCH data on the PUSCH. The UCI multiplexing parameters may include beta offsets to indicate resource offsets (e.g., betaOffsetACK, betaOffsetCSI_part1, and/or betaOffsetCSI_part2) for different types of UCI, UCI dropping rules, and/or UCI multiplexing priority. In this instance, UCI may be multiplexed on the PUSCH with UL-SCH data in accordance with the UCI multiplexing parameters of the applied transmit configuration.

In an aspect, the UCI multiplexing parameters of the applied transmit configuration may include a UCI multiplex indicator. In this instance, the UCI may be allowed to be multiplexed on the PUSCH when the UCI multiplex indicator indicates that UCI multiplexing is enabled.

In an aspect, the UCI multiplexing parameters of the applied transmit configuration may include a UCI only indicator. In this instance, only the UCI may be transmitted on the PUSCH. In other words, UCI only message may be transmitted on the PUSCH when the UCI only indicator indicates that UCI only message is allowed. In an aspect, if the UCI multiplex indicator indicates that UCI multiplexing is disabled, then the UCI may not be allowed to be transmitted on the PUSCH without multiplexing with UL-SCH data.

In yet another aspect, some HARQ processes and/or HARQ process types may be excluded from UCI only without data. In this aspect, the UCI multiplexing parameters may also include a UCI only indicator indicating whether UL-SCH data can or cannot be transmitted on the PUSCH along with the UCI.

An UL message that includes one or more MAC CEs may be transmitted on the PUSCH associated with the HARQ process and/or the HARQ process type. Some MAC CEs may be transmitted only on HARQ processes of the first HARQ process type (retransmission enabled) such that some threshold level of end-to-end delivery reliability can be achieved. For example, MAC CEs that require confirmation (e.g., network node confirms receipt to UE) may be served well with HARQ processes of the first HARQ process type. Configured Grant Confirmation MAC CE and/or Multiple Entry Configured Grant Confirmation MAC CE may be examples of such MAC CEs.

FIG. 4B illustrates another exemplary method 400B performed by a UE (e.g., UE 250) to transmit uplink messages. In method 400B, different transmit configurations may be applied and used on different HARQ processes. The memory component 260 may be viewed as an example of a non-transitory computer-readable medium that stores computer-executable instructions to operate components of the UE 250 such as receiver(s) 254a, transmitter(s) 254b, RX processor 256, TX processor 268, controller/processor 259, HARQ component 266, channel estimator 258, etc. to perform the method 400B.

In block 405B, the UE may configure transmit configurations received from a network node (e.g., network node 210). One or more aspects of block 405B of FIG. 4B may be similar to one or more aspects of block 405A of FIG. 4A. Means for performing block 405B may include antenna(s) 252, receiver(s) 254a, RX processor 256, HARQ component 266, controller/processor 259, memory 260, TX processor 268, and/or transmitter(s) 254b of the UE 250.

In block 410B, when the UE has uplink messages to transmit, the UE may send a scheduling request (SR) to the network node. The SR may specify PUSCH resources associated with desired HARQ processes and/or HARQ process types. That is, the UE may match the request with the UL message (e.g., UL-SCH data, UCI, MAC CE, etc.) to be sent. Means for performing block 410B may include antenna(s) 252, HARQ component 266, controller/processor 259, memory 260, TX processor 268, and/or transmitter(s) 254b of the UE 250.

In block 420B, the UE may receive an uplink grant for PUSCH resources from the network node. One or more aspects of block 420B of FIG. 4B may be similar to one or more aspects of block 420A of FIG. 4A. Means for performing block 420B may include antenna(s) 252, receiver(s) 254a, RX processor 256, controller/processor 259, and/or memory 260 of the UE 250.

In block 430B, the UE may apply a transmit configuration to the PUSCH in accordance with the associated HARQ process and/or with the associated HARQ process type. In this instance, since the association is explicit, specifying the HARQ process and/or the HARQ process type may be sufficient for the UE to determine which transmit configuration to apply and use. Again, it is recognized that when the granted resources of the PUSCH are associated with multiple HARQ processes and/or with multiple HARQ process types, the UE may apply the corresponding transmit configuration to the relevant portions of the PUSCH associated with each HARQ process and/or each HARQ process type. Means for performing block 430B may HARQ component 266, controller/processor 259, and/or memory 260 of the UE 250.

Thus, the applied transmit configuration may be one of a plurality of transmit configurations. At least two of the transmit configurations may be different from each other. For example, they may specify different transmit parameters (e.g., each may specify different MCS table) and/or may specify different UCI multiplexing parameters (e.g., one may specify that UCI and UL-SCH data multiplexing is enabled and another may specify that UCI only is enabled).

The transmit configuration may specify any combination of the one or more transmit parameters (e.g., power control parameters including a loop index, an MCS table, a DMRS pattern, a time-domain allocation pattern, a frequency hopping pattern, a slot aggregation number, etc.). In an aspect, set of each of the parameters can be configured for a HARQ process or HARQ process type. The DCI may include relevant bits to indicate the exact value to be used. For instance, the network may configure a slot aggregation number set [1, 2, 4, 8] and use 2 bits in the DCI to indicate the exact number to be used for HARQ process without retransmission.

In block 440B, the UE may transmit an uplink message (any one or more of UL-SCH data, UCI, MAC CE, etc.) to the network node on the PUSCH. One or more aspects of block 440B of FIG. 4B may be similar to one or more aspects of block 440A of FIG. 4A. Means for performing block 440B may include antenna(s) 252, HARQ component 266, controller/processor 259, memory 260, TX processor 268, and/or transmitter(s) 254b of the UE 250.

FIG. 5A illustrates an exemplary method 500A performed by a network node (e.g., network node 210) to enable a UE to transmit uplink messages. In an aspect, the network node performing the method 500 may be a non-terrestrial network (NTN) node such as a satellite. In method 500A, the UE is enabled to apply different transmit configurations on different HARQ processes. The memory component 276 may be viewed as an example of a non-transitory computer-readable medium that stores computer-executable instructions to operate components of the network node 210 such as receiver(s) 218b, transmitter(s) 218a, RX processor 270, TX processor 216, controller/processor 275, HARQ component 265, channel estimator 274, etc. to perform the method 500A.

At block 505A, the network node may send a plurality of transmit configurations to a UE (e.g., UE 250). Details of the transmit configurations are discussed above with respect to block 405A of FIG. 4A. In this way, the UE may make adjustments to meet requirements of the uplink message (e.g., speed, reliability, etc.). Note that block 505A is optional. That is, the network node may or may not send the transmit configurations. Also, when block 505A is performed, it is not necessary that the network node send all of the transmit configurations. Means for performing block 505A may include antenna(s) 220, transmitter(s) 218a, TX processor 216, HARQ component 265, controller/processor 275, and/or memory 276 of the network node 210.

In block 520A, the network node may send to the UE an uplink grant for PUSCH resources associated with one or more HARQ processes. For example, the network node may send the grant in a DCI. It should be kept in mind that the associated HARQ process and/or the associated HARQ process type can be one of a plurality of HARQ processes and/or one of a plurality of HARQ process types supported by the UE. Generally, in block 520A, the grant may be such that different portions of the granted PUSCH may be associated with one or more HARQ processes and/or with one or more HARQ process types. Means for performing block 520A may include antenna(s) 220, transmitter(s) 218a, TX processor 216, HARQ component 265, controller/processor 275, and/or memory 276 of the network node 210.

A transmit configuration may be applied by the UE to the PUSCH in accordance with the HARQ process and/or the HARQ process types (e.g., see block 440A of FIG. 4A and block 430B of FIG. 4B). The applied transmit configuration may be one of a plurality of transmit configurations, and at least two of the transmit configurations may be different from each other.

In block 540A, the network node may receive an uplink message (any one or more of UL-SCH data, UCI, MAC CE, etc.) from the UE on the PUSCH. It may be said that in block 540A, the network node may receive, from the UE, the UL message on the PUSCH using the transmit configuration in accordance with the associated HARQ process. This is from the perspective of the associated HARQ process and/or the associated HARQ process types. But more generally in block 540A, when the granted resources of the PUSCH are associated with multiple HARQ processes and/or with multiple HARQ process types, then for each HARQ process and/or each HARQ process type, a separate UL message may be carried on relevant portions of the PUSCH associated with the HARQ process and/or the HARQ process type. Further details of the UL message are discussed above with respect to blocks 440A and 440B of FIGS. 4A and 4B. Means for performing block 540A may include antenna(s) 220, receiver(s) 218b, RX processor 270, HARQ component 265, controller/processor 275, and/or memory 276 of the network node 210.

FIG. 5B illustrates another exemplary method 500B performed by a network node (e.g., network node 210) to enable a UE to transmit uplink messages. In method 500B, the UE is enabled to apply different transmit configurations on different HARQ processes. The memory component 276 may be viewed as an example of a non-transitory computer-readable medium that stores computer-executable instructions to operate components of the network node 210 such as receiver(s) 218b, transmitter(s) 218a, RX processor 270, TX processor 216, controller/processor 275, HARQ component 265, channel estimator 274, etc. to perform the method 500B.

At block 505B, the network node may send transmit configurations to a UE (e.g., UE 250). One or more aspects of block 505B of FIG. 5B may be similar to one or more aspects of block 505A of FIG. 5A. Means for performing block 505B may include antenna(s) 220, transmitter(s) 218a, TX processor 216, HARQ component 265, controller/processor 275, and/or memory 276 of the network node 210.

In block 510B, the network node may receive a scheduling request (SR) for PUSCH resource from the UE. In an aspect, The SR may specify PUSCH resources associated with desired HARQ processes and/or HARQ process types. For example, the SR may indicate desired transmit configuration requirements. Means for performing block 510B may include antenna(s) 220, receiver(s) 218b, RX processor 270, controller/processor 275, and/or memory 276 of the network node 210.

In block 520B, the network node may send an uplink grant for PUSCH resources to the UE. One or more aspects of block 520B of FIG. 5B may be similar to one or more aspects of block 520A of FIG. 5A. Means for performing block 520B may include antenna(s) 220, transmitter(s) 218a, TX processor 216, controller/processor 275, and/or memory 276 of the network node 210.

In block 540B, the network node may receive an uplink message (any one or more of UL-SCH data, UCI, MAC CE, etc.) from the UE on the PUSCH. It may be said that in block 540B, the network node may receive, from the UE, the UL message on the PUSCH using the transmit configuration in accordance with the associated HARQ process. One or more aspects of block 540B of FIG. 5B may be similar to one or more aspects of block 540A of FIG. 5A. Means for performing block 540B may include antenna(s) 220, receiver(s) 218b, RX processor 270, HARQ component 265, controller/processor 275, and/or memory 276 of the network node 210.

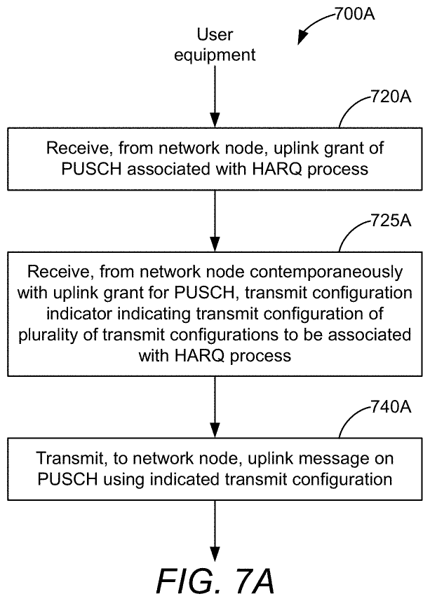

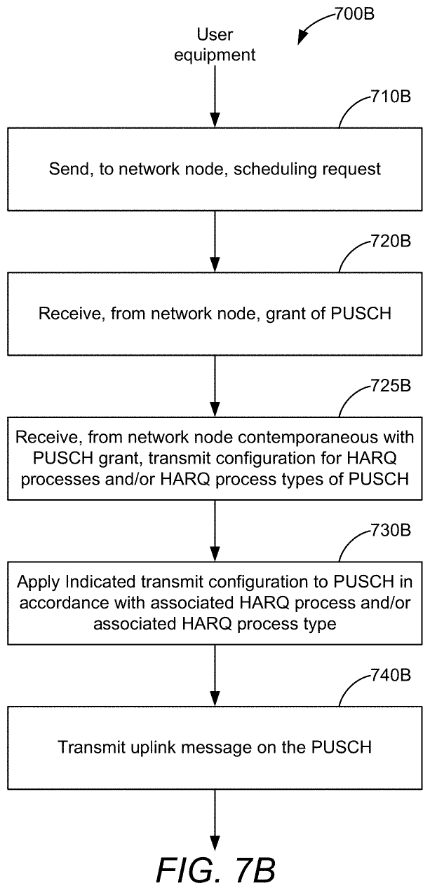

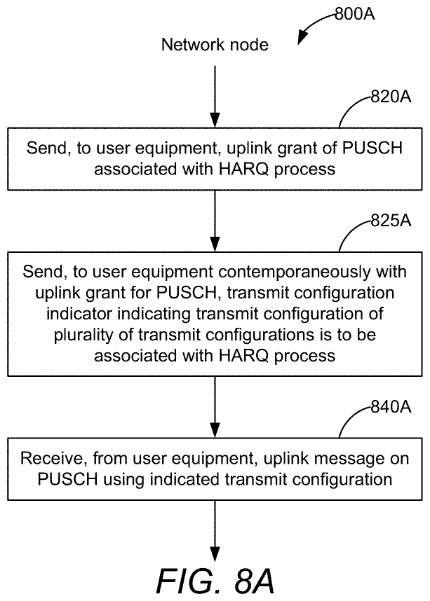

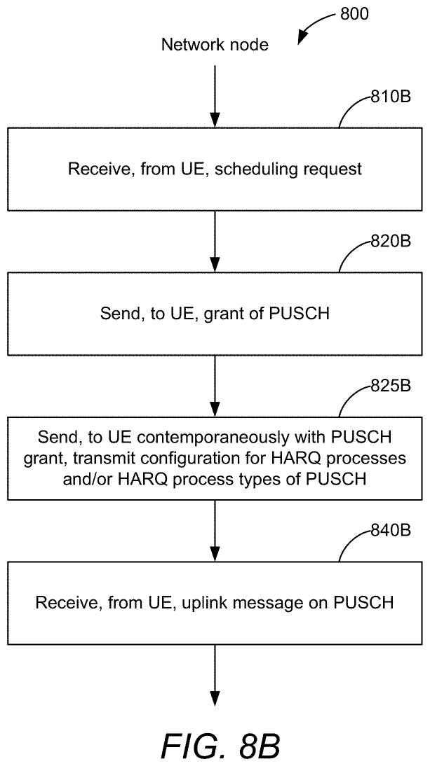

FIG. 6 illustrates an example signaling between the network node and the user equipment. Briefly, the UE may send a scheduling request (SR) to the network node when it has uplink messages to send. The network node may grant the UE with uplink (e.g., PUSCH) resources. Contemporaneously with the scheduling grant, the network node may also indicate which transmit configuration to use applicable to the granted uplink resources. For example, the network may indicate transmit configuration to use in the DCI message notifying the UE of the grant of uplink resources. Alternatively, the network node may indicate the transmit configuration to be used in upcoming uplink grants in a MAC-CE message. If HARQ retransmission is enabled, then the UE may retransmit the message if a subsequent grant indicates retransmission (e.g., new data indicator bit is not toggled). Details are provided with respect to FIGS. 7 and 8.

FIG. 6 may be viewed as an example of an implicit association between HARQ processes and transmit configurations and/or between HARQ process types and transmit configurations. When the association is implicit, then scheduling of PUSCH resources of a specific HARQ process and/or HARQ process type may not be sufficient for the UE to determine which of the transmit configurations to apply and use in the uplink transmission. Thus, along with the scheduling of the PUSCH resources, the network node may notify, contemporaneously with scheduling of PUSCH, the UE of which transmit configuration to use when transmitting uplink messages on the PUSCH.

FIG. 7A illustrates another exemplary method 700A performed by a UE (e.g., UE 250) to transmit uplink messages. In method 700A, different transmit configurations may be applied and used on different HARQ processes. Also in method 700A, associations between HARQ processes and/or HARQ process types and the transmit configurations may be dynamic. For example, a transmit configuration may be applied and used on a HARQ process at one time, and a different transmit configuration may be applied and used on the same HARQ process at a different time. The memory component 260 may be viewed as an example of a non-transitory computer-readable medium that stores computer-executable instructions to operate components of the UE 250 such as receiver(s) 254a, transmitter(s) 254b, RX processor 256, TX processor 268, controller/processor 259, HARQ component 266, channel estimator 258, etc. to perform the method 700A.

In block 720A, the UE may receive an uplink grant for PUSCH resources associated with one or more HARQ processes from a network node. For example, the UE may receive the grant in a DCI. One or more aspects of block 720A may be similar to one or more aspects of block 420A of FIG. 4A. Means for performing block 720A may include antenna(s) 252, receiver(s) 254a, RX processor 256, controller/processor 259, and/or memory 260 of the UE 250.

In block 725A, the UE may receive a transmit configuration indicator indicating which of the plurality of transmit configurations is to be selected as the transmit configuration applied to the granted PUSCH. To state it another way, in block 725A, the UE may receive, from the network node, a transmit configuration indicator indicating which of the plurality of transmit configurations is the transmit configuration associated with the HARQ process. Means for performing block 725A may include antenna(s) 252, receiver(s) 254a, RX processor 256, HARQ component 266, controller/processor 259, memory 260, TX processor 268, and/or transmitter(s) 254b of the UE 250.

The transmit configuration indicator may be received contemporaneously with the UL grant for the PUSCH resources. For example, the transmit configuration indicator may be received in the same DCI. In another example, the transmit configuration indicator may be received in a downlink MAC-CE message from the network node, e.g., prior to receiving the UL grant. In an aspect, when the transmit configuration indicator and the UL grant are received contemporaneously, the UE may recognize that the transmit configuration indicator is applicable to the PUSCH resources of that UL grant.

In an aspect, the indicated transmit configuration (i.e., transmit configuration indicated by the transmit configuration indicator) may be associated with the HARQ process itself (i.e., individualized for the HARQ process). In another aspect, the indicated transmit configuration may be associated with a HARQ process type of the HARQ process. This can be useful when multiple portions of the scheduled PUSCH resources correspond to HARQ processes of same HARQ process type. In such situation, a single transmit configuration indicator may be sufficient.

In block 740A, the UE may transmit an uplink message (any one or more of UL-SCH data, UCI, MAC CE, etc.) to the network node on the PUSCH. The UL message may be transmitted on the PUSCH associated with the HARQ process and/or HARQ process type in accordance with the indicated transmit configuration. It may be said that in block 740A, the UE may transmit, to the network node, the UL message on the PUSCH using the indicated transmit configuration. This is from the perspective of the associated HARQ process and/or the associated HARQ process types. One or more aspects of block 740 may be similar to one or more aspects of block 440A of FIG. 4A. Means for performing block 740A may include antenna(s) 252, HARQ component 266, controller/processor 259, memory 260, TX processor 268, and/or transmitter(s) 254b of the UE 250.

FIG. 7B illustrates another method 700B performed by a UE (e.g., UE 250) to transmit uplink messages. In method 700B, different transmit configurations may be applied and used on different HARQ processes. Also in method 700B, associations between HARQ processes and/or HARQ process types and the transmit configurations may be dynamic.

In block 710B, when the UE has uplink messages to transmit, the UE may send a scheduling request (SR) to the network node. The SR may specify PUSCH resources associated with desired HARQ processes and/or HARQ process types. That is, the UE may match the request with the UL message (e.g., UL-SCH data, UCI, MAC CE, etc.) to be sent. One or more aspects of block 710B may be similar to one or more aspects of block 410B of FIG. 4B. Means for performing block 710B may include antenna(s) 252, HARQ component 266, controller/processor 259, memory 260, TX processor 268, and/or transmitter(s) 254b of the UE 250.

In block 720B, the UE may receive an uplink grant for PUSCH resources from the network node. For example, the UE may receive a DCI. One or more aspects of block 720B of FIG. 7B may be similar to one or more aspects of block 720A of FIG. 7A. Means for performing block 720B may include antenna(s) 252, receiver(s) 254a, RX processor 256, controller/processor 259, and/or memory 260 of the UE 250.

In block 725B the UE may receive a transmit configuration indicator indicating which of the plurality of transmit configurations is to be selected as the transmit configuration applied to the granted PUSCH. That is, the UE may receive, from the network node, a transmit configuration indicator indicating which of the plurality of transmit configurations is the transmission indicator associated with the HARQ process. The transmit configuration indicator may be received contemporaneously with the UL grant for the PUSCH resources. One or more aspects of block 725B of FIG. 7B may be similar to one or more aspects of block 725A of FIG. 7A. Means for performing block 725B may include antenna(s) 252, receiver(s) 254a, RX processor 256, HARQ component 266, controller/processor 259, memory 260, TX processor 268, and/or transmitter(s) 254b of the UE 250.

In block 730B, the UE may apply the indicated transmit configuration to the PUSCH in accordance with the associated HARQ process and/or with the associated HARQ process type. It should be noted that in an aspect, even if there are explicit mappings between transmit configurations and HARQ processes and/or HARQ process types, if the transmit configuration is contemporaneously indicated, then at least for that granted PUSCH, the indicated transmit configuration may be applied. Means for performing block 730B may HARQ component 266, controller/processor 259, and/or memory 260 of the UE 250.

It should be noted if the granted resources of the PUSCH are associated with multiple HARQ processes and/or with multiple HARQ process types, the UE may receive one or more transmit configuration indicators in block 725B in which each transmit configuration may be mapped to a HARQ process and/or a HARQ process type of the granted PUSCH. The UE in block 730B may apply the indicated transmit configurations to the relevant portions of the PUSCH associated with each HARQ process and/or each HARQ process type.

In block 740B, the UE may transmit an uplink message (any one or more of UL-SCH data, UCI, MAC CE, etc.) to the network node on the PUSCH. One or more aspects of block 740B of FIG. 7B may be similar to one or more aspects of block 740A of FIG. 7A. Means for performing block 740B may include antenna(s) 252, HARQ component 266, controller/processor 259, memory 260, TX processor 268, and/or transmitter(s) 254b of the UE 250.

FIG. 8A illustrates another exemplary method 800A performed by a network node (e.g., network node 210) to enable to enable a UE to transmit uplink messages. In an aspect, the network node performing the method 800 may be a non-terrestrial network (NTN) node such as a satellite. In method 800A, the UE is enabled to apply different transmit configurations on different HARQ processes. Also in method 800A, associations between HARQ processes and/or HARQ process types and the transmit configurations may be dynamic. The memory component 276 may be viewed as an example of a non-transitory computer-readable medium that stores computer-executable instructions to operate components of the network node 210 such as receiver(s) 218b, transmitter(s) 218a, RX processor 270, TX processor 216, controller/processor 275, HARQ component 265, channel estimator 274, etc. to perform the method 800A.

In block 820A, the network node may send to the UE an uplink grant for PUSCH resources associated with one or more HARQ processes. One or more aspects of block 820A may be similar to one or more aspects of block 520A of FIG. 5A. Means for performing block 820A may include antenna(s) 220, transmitter(s) 218a, TX processor 216, HARQ component 265, controller/processor 275, and/or memory 276 of the network node 210.

In block 825A, the network node may send, to the UE contemporaneously with the UL grant for the PUSCH, a transmit configuration indicator indicating which of the plurality of transmit configurations is to be selected as the transmit configuration applied to the granted PUSCH on the UE side. To state it another way, in block 825A, the network node may send, to the UE, a transmit configuration indicator indicating which of the plurality of transmit configurations is the transmit configuration associated with the HARQ process. The transmit configuration indicator may be sent contemporaneously with the UL grant for the PUSCH resources (e.g., in DCI or downlink MAC-CE). Details of the transmit configuration indicator are described above with respect to block 725A of FIG. 7A. Means for performing block 825A may include antenna(s) 220, transmitter(s) 218a, TX processor 216, HARQ component 265, controller/processor 275, and/or memory 276 of the network node 210.

In block 840A, the network node may receive an uplink message (any one or more of UL-SCH data, UCI, MAC CE, etc.) from the UE on the PUSCH. It may be said that in block 840A, the network node may receive, from the UE, the UL message on the PUSCH using the indicated transmit configuration. This is from the perspective of the associated HARQ process and/or the associated HARQ process types. One or more aspects of block 840A of FIG. 8A may be similar to one or more aspects of block 540A of FIG. 5A. Means for performing block 840A may include antenna(s) 220, receiver(s) 218b, RX processor 270, HARQ component 265, controller/processor 275, and/or memory 276 of the network node 210.

FIG. 8B illustrates an exemplary method 800 performed by a network node (e.g., network node 210) to enable to enable a UE to transmit uplink messages. In an aspect, the network node performing the method 800 may be a non-terrestrial network (NTN) node such as a satellite. In method 800B, the UE is enabled to apply different transmit configurations on different HARQ processes. Also in method 800B, associations between HARQ processes and/or HARQ process types and the transmit configurations may be dynamic. The memory component 276 may be viewed as an example of a non-transitory computer-readable medium that stores computer-executable instructions to operate components of the network node 210 such as receiver(s) 218b, transmitter(s) 218a, RX processor 270, TX processor 216, controller/processor 275, HARQ component 265, channel estimator 274, etc. to perform the method 800B.

In block 810, the network node may receive a scheduling request (SR) for PUSCH resource from the UE. In an aspect, The SR may specify PUSCH resources associated with desired HARQ processes and/or HARQ process types. For example, the SR may indicate desired transmit configuration requirements. One or more aspects of block 810 of FIG. 8B may be similar to one or more aspects of block 510B of FIG. 5B. Means for performing block 810 may include antenna(s) 220, receiver(s) 218b, RX processor 270, controller/processor 275, and/or memory 276 of the network node 210.

In block 820B, the network node may send an uplink grant for PUSCH resources to the UE, e.g., in a DCI. One or more aspects of block 820B of FIG. 8B may be similar to one or more aspects of block 820A of FIG. 8A. Means for performing block 820B may include antenna(s) 220, transmitter(s) 218a, TX processor 216, controller/processor 275, and/or memory 276 of the network node 210.

In block 825B, the network node may send a transmit configuration indicator indicating which of the plurality of transmit configurations is to be selected as the transmit configuration applied to the granted PUSCH on the UE side. That is, the transmit configuration indicator may indicate which of the plurality of transmit configurations is the transmit configuration associated with the HARQ process. The transmit configuration indicator may be sent contemporaneously with the UL grant for the PUSCH resources (e.g., in DCI or downlink MAC-CE). One or more aspects of block 825B of FIG. 8B may be similar to one or more aspects of block 825A of FIG. 8A. Means for performing block 825B may include antenna(s) 220, transmitter(s) 218a, TX processor 216, HARQ component 265, controller/processor 275, and/or memory 276 of the network node 210.

In block 840B, the network node may receive an uplink message (any one or more of UL-SCH data, UCI, MAC CE, etc.) from the UE on the PUSCH. One or more aspects of block 840B of FIG. 8B may be similar to one or more aspects of block 840A of FIG. 8A. Means for performing block 840B may include antenna(s) 220, receiver(s) 218b, RX processor 270, HARQ component 265, controller/processor 275, and/or memory 276 of the network node 210.

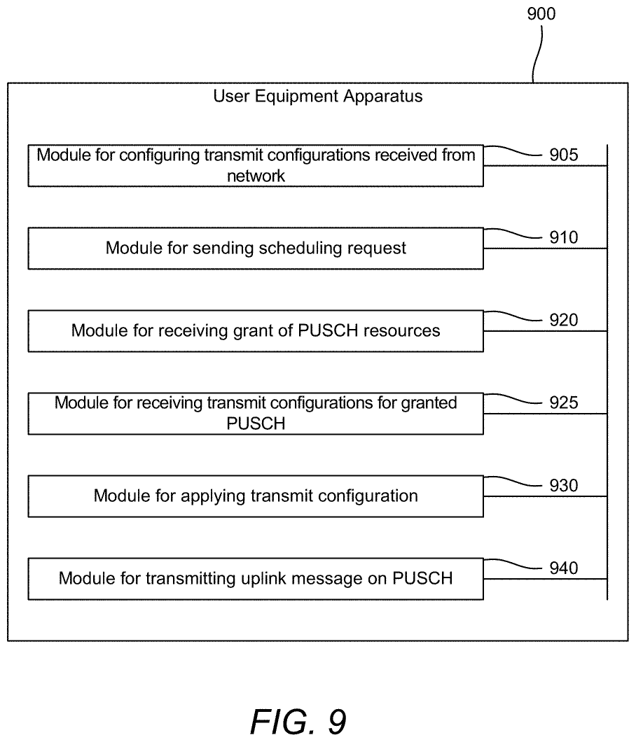

FIG. 9 illustrates an example user equipment apparatus 900 for implementing methods 400A, 400B, 700A and 700B of FIGS. 4A, 4B, 7A and 7B represented as a series of interrelated functional modules in accordance with an aspect of the disclosure. In the illustrated example, the apparatus 900 may include a module 905 for configuring transmit configurations, a module 910 sending a scheduling request, a module 920 for receiving a grant of PUSCH, a module 925 for receiving transmit configurations for granted PUSCH, a module 930 for applying transmit configuration, and a module 940 for transmitting uplink messages. The module 905 may be configured to perform blocks 405A and 405B of FIGS. 4A and 4B. In an aspect, the module 905 may be implemented through antenna(s) 252, receiver(s) 254a, RX processor 256, HARQ component 266, controller/processor 259, memory 260, TX processor 268, and/or transmitter(s) 254b of the UE 250. The module 910 may be configured to perform block 410B of FIG. 4B and/or block 710B of FIG. 7B. In an aspect, the module 910 may be implemented through antenna(s) 252, HARQ component 266, controller/processor 259, memory 260, TX processor 268, and/or transmitter(s) 254b of the UE 250. The module 920 may be configured to perform blocks 420A and 420B of FIGS. 4A and 4B and/or blocks 720A and 720B of FIGS. 7A and 7B. In an aspect, the module 920 may be implemented through antenna(s) 252, receiver(s) 254a, RX processor 256, controller/processor 259, and/or memory 260 of the UE 250. The module 925 may be configured to perform block 725A and 725B of FIGS. 7A and 7B. In an aspect, the module 925 may be implemented through antenna(s) 252, receiver(s) 254a, RX processor 256, HARQ component 266, controller/processor 259, memory 260, TX processor 268, and/or transmitter(s) 254b of the UE 250. The module 930 may be configured to perform block 430B of FIG. 4B and/or block 730B of FIG. 7B. In an aspect, the module 930 may be implemented through HARQ component 266, controller/processor 259, memory 260, and/or TX processor 268 of the UE 250. The module 940 may be configured to perform blocks 440A and 440B of FIGS. 4A and 4B and/or blocks 740A and 740B of FIGS. 7A and 7B. In an aspect, the module 940 may be implemented through antenna(s) 252, HARQ component 266, controller/processor 259, memory 260, TX processor 268, and/or transmitter(s) 254b of the UE 250.

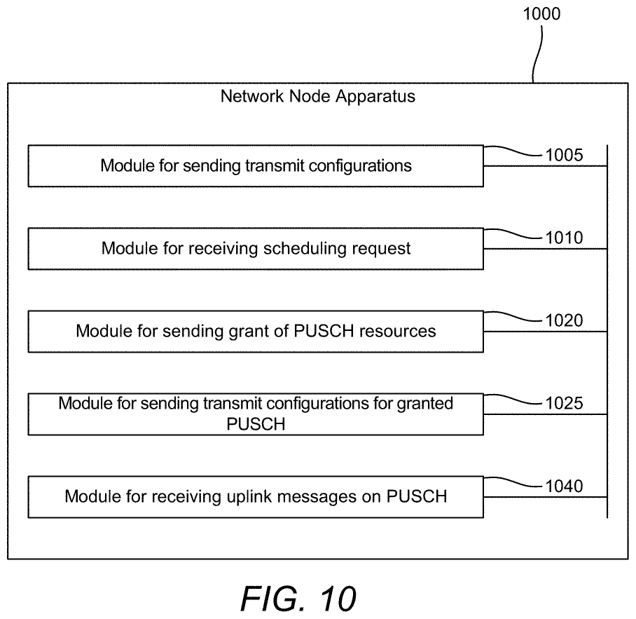

FIG. 10 illustrates an example network node apparatus 1000 for implementing methods 500A, 500B, 800A and 800B of FIGS. 5A, 5B, 8A and 8B represented as a series of interrelated functional modules in accordance with an aspect of the disclosure. In the illustrated example, the apparatus 1000 may include a module 1005 for sending transmit configurations, a module 1010 for receiving a scheduling request, a module 1020 for sending a grant PUSCH resources, a module 1025 for sending transmit configurations for granted PUSCH, and a module 1040 for receiving uplink messages on the PUSCH. The module 1005 may be configured to perform blocks 505A and 505B of FIGS. 5A and 5B. In an aspect, the module 1005 may be implemented through antenna(s) 220, transmitter(s) 218a, TX processor 216, HARQ component 265, controller/processor 275, and/or memory 276 of the network node 210. The module 1010 may be configured to perform block 510B of FIG. 5B and/or block 810 of FIG. 8B. In an aspect, the module 1010 may be implemented through antenna(s) 220, receiver(s) 218b, RX processor 270, controller/processor 275, and/or memory 276 of the network node 210. The module 1020 may be configured to perform blocks 520A and 520B of FIGS. 5A and 5B and/or blocks 820A and 820B of FIGS. 8A and 8B. In an aspect, the module 1020 may be implemented through antenna(s) 220, transmitter(s) 218a, TX processor 216, HARQ component 265, controller/processor 275, and/or memory 276 of the network node 210. The module 1025 may be configured to perform blocks 825A and 825B of FIGS. 8A and 8B. In an aspect, the module 1025 may be implemented through antenna(s) 220, transmitter(s) 218a, TX processor 216, HARQ component 265, controller/processor 275, and/or memory 276 of the network node 210. The module 1040 may be configured to perform blocks 540A and 540B of FIGS. 5A and 5B and/or blocks 840A and 840B of FIGS. 8A and 8B. In an aspect, the module 1040 may be implemented through antenna(s) 220, receiver(s) 218b, RX processor 270, HARQ component 265, controller/processor 275, and/or memory 276 of the network node 210.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1: A method of communication of a user equipment (UE), comprising: receiving, from a network node, an uplink (UL) grant for a physical uplink shared channel (PUSCH) associated with a hybrid automatic repeat request (HARQ) process; applying a transmit configuration to the PUSCH in accordance with the associated HARQ process, the applied transmit configuration being one of a plurality of transmit configurations, each of the plurality of transmit configurations being associated with a HARQ process, and at least two of the plurality of transmit configurations being different from each other; and transmitting, to the network node, an UL message on the PUSCH.

Clause 2: The method of clause 1, wherein the network node is a non-terrestrial network (NTN) node.

Clause 3: The method of any of clauses 1-2, wherein the UL message comprises any one or more of an UL-SCH data, uplink control information (UCI), and/or a medium access control (MAC) control element (CE).

Clause 4: The method of any of clause 1-3, wherein the HARQ process types include a first HARQ process type in which HARQ retransmission is enabled and a second HARQ process type in which HARQ retransmission is disabled.

Clause 5: The method of clause 4, wherein the HARQ process is one of a plurality of HARQ processes, each HARQ process being one of the first and second HARQ process types.

Clause 6: The method of any of clauses 4-5, wherein the transmit configuration applied to the PUSCH defines transmit parameters comprising one or more of: power control parameters including a loop index, a modulation and coding scheme (MCS) table, a demodulation reference signal (DMRS) pattern, a time-domain allocation pattern, a frequency hopping pattern, and/or a slot aggregation number.

Clause 7: The method of any of clauses 4-6, wherein the UE is configured with a plurality of default transmit configurations as the plurality of transmit configurations.

Clause 8: The method of any of clauses 4-7, further comprising: receiving the plurality of transmit configurations from the network node.

Clause 9: The method any of clauses 4-8, wherein UL message comprises an uplink control information (UCI), wherein the applied transmit configuration further defines UCI multiplexing parameters for multiplexing UCI and UL-SCH data on the PUSCH, the UCI multiplexing parameters comprising one or more of beta offsets to indicate resource offsets for different types of UCI, UCI dropping rules, and/or UCI multiplexing priority, and wherein transmitting the UL message comprises multiplexing the UCI on the PUSCH in accordance with the specified UCI multiplexing parameters.

Clause 10: The method of clause 9, wherein the beta offsets comprise one or more of betaOffsetACK, betaOffsetCSI_part1, and/or betaOffsetCSI_part2.

Clause 11: The method of any of clauses 4-10, wherein the UCI multiplexing parameters further comprises a UCI only indicator, and wherein the UCI is not allowed to be transmitted on the PUSCH without multiplexing with UL-SCH data when the UCI multiplex indicator indicates that UCI multiplexing is disabled.

Clause 12: The method of any of clauses 4-10, wherein the UCI multiplexing parameters further comprises a UCI only indicator, and wherein UCI only message is transmitted on the PUSCH when the UCI only indicator indicates that UCI only message is allowed.

Clause 13: The method of any of clauses 4-8, wherein the UL message comprises a medium access control (MAC) control element (CE), and wherein transmitting the UL messages comprises: transmitting the UL message on the PUSCH when the associated HARQ process type is the first HARQ process type.

Clause 14: The method of clause 13, wherein when the MAC CE is a Configured Grant Confirmation MAC CE or a Multiple Entry Configured Grant Confirmation MAC CE, the UL message is transmitted on the PUSCH when the associated HARQ process type is the first HARQ process type.

Clause 15: A method of communication of a network node, comprising: sending, to a user equipment (UE), an uplink (UL) grant for a physical uplink shared channel (PUSCH) associated with a hybrid automatic repeat request (HARQ) process; and receiving, from the UE, an UL message on the PUSCH, a transmit configuration being applied to the PUSCH in accordance with the associated HARQ process, the applied transmit configuration being one of a plurality of transmit configurations, each of the plurality of transmit configurations being associated with a HARQ process, and at least two of the plurality of transmit configurations being different from each other.

Clause 16: The method of clause 15, wherein the network node is a non-terrestrial network (NTN) node.

Clause 17: The method of any of clauses 15-16, wherein the UL message comprises any one or more of an UL-SCH data, uplink control information (UCI), and/or a medium access control (MAC) control element (CE).

Clause 18: The method of any of clauses 15-17, wherein the HARQ process types include a first HARQ process type in which HARQ retransmission is enabled and a second HARQ process type in which HARQ retransmission is disabled.

Clause 19: The method of clause 18, wherein each HARQ process is one of the first and second HARQ process types.

Clause 20: The method of any of clauses 18-19, wherein the transmit configuration applied to the PUSCH defines transmit parameters comprising one or more of: power control parameters including a loop index, a modulation and coding scheme (MCS) table, a demodulation reference signal (DMRS) pattern, a time-domain allocation pattern, a frequency hopping pattern, and/or a slot aggregation number.

Clause 21: The method of any of clauses 18-20, wherein the UE is configured with a plurality of default transmit configurations as the plurality of transmit configurations.

Clause 22: The method of any of clauses 18-21, further comprising: sending the plurality of transmit configurations to the UE.

Clause 23: The method any of clauses 18-22, wherein UL message comprises an uplink control information (UCI), wherein the applied transmit configuration further defines UCI multiplexing parameters for multiplexing UCI and UL-SCH data on the PUSCH, the UCI multiplexing parameters comprising one or more of beta offsets to indicate resource offsets for different types of UCI, UCI dropping rules, and/or UCI multiplexing priority, and wherein the UCI is multiplexed on the PUSCH.

Clause 24: The method of clause 23, wherein the beta offsets comprise one or more of betaOffsetACK, betaOffsetCSI_part1, and/or betaOffsetCSI_part2.

Clause 25: The method of any of clauses 18-24, wherein the UCI multiplexing parameters further comprises a UCI multiplex indicator, and wherein the UCI is allowed to be multiplexed on the PUSCH when the UCI multiplex indicator indicates that UCI multiplexing is enabled.

Clause 26: The method of any of clauses 18-24, wherein the UCI multiplexing parameters further comprises a UCI only indicator, wherein the UCI is not allowed to be transmitted on the PUSCH without multiplexing with UL-SCH data when the UCI multiplex indicator indicates that UCI multiplexing is disabled.

Clause 27: The method of any of clauses 18-22, wherein the UL message comprises a medium access control (MAC) control element (CE), and wherein the UL message is received on the PUSCH when the associated HARQ process type is the first HARQ process type.

Clause 28: The method of clause 27, wherein when the MAC CE is a Configured Grant Confirmation MAC CE or a Multiple Entry Configured Grant Confirmation MAC CE, the UL message is received on the PUSCH when the associated HARQ process type is the first HARQ process type.

Clause 29: A user equipment comprising at least one means for performing a method of any of clauses 1-14.

Clause 30: A network node comprising at least one means for performing a method of any of clauses 15-28.

Clause 31: A user equipment comprising a processor, memory coupled with the processor, the processor and memory configured perform a method of any of clauses 1-14.

Clause 32: A network node comprising a processor, memory coupled with the processor, the processor and memory configured perform a method of any of clauses 15-28.

Clause 33: A non-transitory computer-readable medium storing code for a user equipment comprising a processor, memory coupled with the processor, and instructions stored in the memory and executable by the processor to cause the user equipment to perform a method of any of clauses 1-14.

Clause 34: A non-transitory computer-readable medium storing code for a network node comprising a processor, memory coupled with the processor, and instructions stored in the memory and executable by the processor to cause the network node to perform a method of any of clauses 15-28.

Clause 35: A method of communication of a user equipment (UE), the method comprising: receiving, from a network node, an uplink (UL) grant for a physical uplink shared channel (PUSCH) associated with a hybrid automatic repeat request (HARQ) process; and transmitting, to the network node, an UL message on the PUSCH using a transmit configuration in accordance with the associated HARQ process, the transmit configuration being one of a plurality of transmit configurations, and at least two of the plurality of transmit configurations being configured for different HARQ processes.

Clause 36: The method of clause 35, wherein the network node is a non-terrestrial network (NTN) node.

Clause 37: The method of any of clauses 35-36, wherein the HARQ process is one of a plurality of HARQ processes configured in the UE, each of the plurality of HARQ processes being one of a plurality of HARQ process types, each HARQ process type being based on at least a HARQ retransmission status, and wherein the plurality of HARQ process types includes at least first and second HARQ process types, the first HARQ process type having the HARQ retransmission status as enabled, and the second HARQ process type having the HARQ retransmission status as disabled.

Clause 38: The method of clause 37, further comprising: receiving, from the network node, the plurality of transmit configurations prior to receiving the UL grant for the PUSCH, wherein the network node specifies associations between the plurality of transmit configurations and the plurality of HARQ processes, between the plurality of transmit configurations and the plurality of HARQ process types, or both, and wherein the HARQ process is sufficient to determine the transmit configuration to be used.

Clause 39: The method of clause 37, further comprising: receiving, from the network node contemporaneously with the UL grant for the PUSCH, a transmit configuration indicator indicating which of the plurality of transmit configurations is the transmit configuration associated with the HARQ process.

Clause 40: The method of clause 39, wherein the UL grant for the PUSCH is included in a downlink control information (DCI) received from the network node, the DCI further including the transmit configuration indicator.

Clause 41: The method of clause 39, wherein the transmit configuration indicator is included in a downlink medium access control (MAC) control element (CE) received from the network node.

Clause 42: The method of any of clauses 35-41, wherein the transmit configuration defines one or more transmit parameters comprising a combination of one or more of: power control parameters including a loop index, a modulation and coding scheme (MCS) table, a demodulation reference signal (DMRS) pattern, a time-domain allocation pattern, a frequency hopping pattern, or a slot aggregation number.

Clause 43: The method of any of clauses 35-42, wherein the UL message comprises an uplink control information (UCI), wherein the transmit configuration further defines one or more UCI multiplexing parameters for multiplexing the UCI and UL-SCH data on the PUSCH, the one or more UCI multiplexing parameters comprising beta offsets to indicate one or more of resource offsets for different types of UCI, one or more UCI dropping rules, or UCI multiplexing priority, and wherein the UCI is multiplexed on the PUSCH in accordance with the one or more UCI multiplexing parameters.

Clause 44: The method of any of clauses 35-43, wherein the UL message comprises an uplink medium access control (MAC) control element (CE), and wherein the UL message is transmitted on the PUSCH in response to the associated HARQ process type being the first HARQ process type.

Clause 45: A user equipment comprising at least one means for performing a method of any of clauses 35-44.

Clause 46: A user equipment comprising a processor, memory coupled with the processor, the processor and memory configured perform a method of any of clauses 35-44.

Clause 47: A non-transitory computer-readable medium storing code for a user equipment comprising a processor, memory coupled with the processor, and instructions stored in the memory and executable by the processor to cause the user equipment to perform a method of any of clauses 35-44.

Clause 48: A method of communication of a network node, the method comprising: sending, to a user equipment (UE), an uplink (UL) grant for a physical uplink shared channel (PUSCH) associated with a hybrid automatic repeat request (HARQ) process; and receiving an UL message transmitted by the UE on the PUSCH using a transmit configuration in accordance with the associated HARQ process, the transmit configuration being one of a plurality of transmit configurations, and at least two of the plurality of transmit configurations being different from each other.

Clause 49: The method of clause 48, wherein the network node is a non-terrestrial network (NTN) node.

Clause 50: The method of any of clauses 48-49, wherein the HARQ process is one of a plurality of HARQ processes configured in the UE, each of the plurality of HARQ processes being one of a plurality of HARQ process types, each HARQ process type being based on at least a HARQ retransmission status, and wherein the plurality of HARQ process types includes at least first and second HARQ process types, the first HARQ process type having the HARQ retransmission status as enabled, and the second HARQ process type having the HARQ retransmission status as disabled.

Clause 51: The method of clause 50, further comprising: sending, to the UE, the plurality of transmit configurations prior to sending the UL grant for the PUSCH, wherein the network node specifies associations between the plurality of transmit configurations and the plurality of HARQ processes, between the plurality of transmit configurations and the plurality of HARQ process types, or both, and wherein the HARQ process is sufficient to determine the transmit configuration to be used.

Clause 52: The method of clause 50, further comprising: sending, to the UE contemporaneously with the UL grant for the PUSCH, a transmit configuration indicator indicating which of the plurality of transmit configurations is the transmit configuration associated with the HARQ process.

Clause 53: The method of clause 52, wherein the UL grant for the PUSCH is included in a downlink control information (DCI) sent to the UE, the DCI further including the transmit configuration indicator.

Clause 54: The method of clause 52, wherein the transmit configuration indicator is included in a downlink medium access control (MAC) control element (CE) sent to the UE.

Clause 55: The method of any of clauses 48-54, wherein the transmit configuration defines one or more transmit parameters comprising a combination of one or more of: power control parameters including a loop index, a modulation and coding scheme (MCS) table, a demodulation reference signal (DMRS) pattern, a time-domain allocation pattern, a frequency hopping pattern, or a slot aggregation number.

Clause 56: The method of any of clauses 48-55, wherein the UL message comprises an uplink control information (UCI), wherein the transmit configuration further defines one or more UCI multiplexing parameters for multiplexing the UCI and UL-SCH data on the PUSCH, the one or more UCI multiplexing parameters comprising beta offsets to indicate one or more of resource offsets for different types of UCI, one or more UCI dropping rules, or UCI multiplexing priority, and wherein the UCI is multiplexed on the PUSCH in accordance with the one or more UCI multiplexing parameters.

Clause 57: The method of any of clauses 48-56, wherein the UL message comprises an uplink medium access control (MAC) control element (CE), and wherein the UL message is received on the PUSCH in response to the associated HARQ process type being the first HARQ process type.

Clause 58: A network node comprising at least one means for performing a method of any of clauses 48-57.

Clause 59: A network node comprising a processor, memory coupled with the processor, the processor and memory configured perform a method of any of clauses 48-57.

Clause 60: A network node computer-readable medium storing code for a user equipment comprising a processor, memory coupled with the processor, and instructions stored in the memory and executable by the processor to cause the network node to perform a method of any of clauses 48-57.

Clause 61: A method of communication of a user equipment (UE), the method comprising: receiving, from a network node, an uplink (UL) grant for a physical uplink shared channel (PUSCH) for a hybrid automatic repeat request (HARQ) process; receiving, from the network node contemporaneously with the UL grant for the PUSCH, a transmit configuration indicator indicating a transmit configuration of a plurality of transmit configurations to be associated with the HARQ process; and transmitting, to the network node, an UL message on the PUSCH using the indicated transmit configuration.

Clause 62: The method of clause 61, wherein each of the plurality of transmit configurations specifies one or more transmit parameters comprising a combination of one or more of: power control parameters including a loop index, a modulation and coding scheme (MCS) table, a demodulation reference signal (DMRS) pattern, a time-domain allocation pattern, a frequency hopping pattern, or a slot aggregation number.

Clause 63: The method of any of clauses 61-62, wherein the HARQ process is one of a plurality of HARQ processes configured in the UE, each of the plurality of HARQ processes being one of a plurality of HARQ process types, each HARQ process type being based on at least a HARQ retransmission status, and wherein the plurality of HARQ process types includes at least first and second HARQ process types, the first HARQ process type having the HARQ retransmission status as enabled, and the second HARQ process type having the HARQ retransmission status as disabled.

Clause 64: The method of any of clauses 61-63, wherein the UL grant for the PUSCH is included in a downlink control information (DCI) received from the network node, the DCI further including the transmit configuration indicator.

Clause 65: The method of any of clauses 61-63, wherein the transmit configuration indicator is included in a downlink medium access control (MAC) control element (CE) received from the network node.

Clause 66: A user equipment comprising at least one means for performing a method of any of clauses 60-65.

Clause 67: A user equipment comprising a processor, memory coupled with the processor, the processor and memory configured perform a method of any of clauses 60-65.

Clause 68: A non-transitory computer-readable medium storing code for a user equipment comprising a processor, memory coupled with the processor, and instructions stored in the memory and executable by the processor to cause the user equipment to perform a method of any of clauses 60-65.

Clause 69: A method of communication of a network node, the method comprising: sending, to a user equipment (UE), an uplink (UL) grant for a physical uplink shared channel (PUSCH) for a hybrid automatic repeat request (HARQ) process; sending, to the UE contemporaneously with the UL grant for the PUSCH, a transmit configuration indicator indicating which of a plurality of transmit configurations is to be associated with the HARQ process; and receiving, from the UE, an UL message on the PUSCH using the indicated transmit configuration.

Clause 70: The method of clause 69, wherein each of the plurality of transmit configurations specifies one or more transmit parameters comprising a combination of one or more of: power control parameters including a loop index, a modulation and coding scheme (MCS) table, a demodulation reference signal (DMRS) pattern, a time-domain allocation pattern, a frequency hopping pattern, or a slot aggregation number.

Clause 71: The method of any of clauses 69-70, wherein the HARQ process is one of a plurality of HARQ processes configured in the UE, each of the plurality of HARQ processes being one of a plurality of HARQ process types, each HARQ process type being based on at least a HARQ retransmission status, and wherein the plurality of HARQ process types includes at least first and second HARQ process types, the first HARQ process type having the HARQ retransmission status as enabled, and the second HARQ process type having the HARQ retransmission status as disabled.

Clause 72: The method of any of clauses 69-71, wherein the UL grant for the PUSCH is included in a downlink control information (DCI) sent to the UE, the DCI further including the transmit configuration indicator.

Clause 73: The method of any of clauses 69-71, wherein the transmit configuration indicator is included in a downlink medium access control (MAC) control element (CE) received from the network node.

Clause 74: A network node comprising at least one means for performing a method of any of clauses 69-73.

Clause 75: A network node comprising a processor, memory coupled with the processor, the processor and memory configured perform a method of any of clauses 69-73.

Clause 76: A network node computer-readable medium storing code for a user equipment comprising a processor, memory coupled with the processor, and instructions stored in the memory and executable by the processor to cause the network node to perform a method of any of clauses 69-73.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations).

The methods, sequences, and/or algorithms described in connection with the aspects disclosed herein may be implemented directly in hardware, in a software module executed by a processor, or in a combination of the two. A software module may reside in Random Access Memory (RAM), flash memory, Read-Only Memory (ROM), Erasable Programmable ROM (EPROM), Electrically Erasable Programmable ROM (EEPROM), registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in a user device (e.g., a UE) or a base station. In the alternative, the processor and the non-transitory computer-readable medium may be discrete components in a user device or base station.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes a Compact Disk (CD), laser disc, optical disk, Digital Video Disk (DVD), floppy disk, and Blu-ray discs, which usually reproduce data magnetically and/or optically with lasers. Combinations of the above should also be included within the scope of computer-readable media.

While the foregoing disclosure shows illustrative aspects, those skilled in the art will appreciate that various changes and modifications could be made herein without departing from the scope of the disclosure as defined by the appended claims. Furthermore, in accordance with the various illustrative aspects described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A user equipment (UE), comprising:
a memory; and
at least one processor coupled to the memory,
wherein the memory and the at least one processor are configured to:
receive, from a network node, an uplink (UL) grant for a physical uplink shared channel (PUSCH) associated with a hybrid automatic repeat request (HARQ) process; and
transmit, to the network node, an UL message on the PUSCH using a transmit configuration in accordance with the associated HARQ process, the transmit configuration being one of a plurality of transmit configurations, and at least two of the plurality of transmit configurations being configured for different HARQ processes.

2. The UE of claim 1, wherein the network node is a non-terrestrial network (NTN) node.

3. The UE of claim 1,
wherein the HARQ process is one of a plurality of HARQ processes configured in the UE, each of the plurality of HARQ processes being one of a plurality of HARQ process types, each HARQ process type being based on at least a HARQ retransmission status, and
wherein the plurality of HARQ process types includes at least first and second HARQ process types,
the first HARQ process type having the HARQ retransmission status as enabled, and
the second HARQ process type having the HARQ retransmission status as disabled.

4. The UE of claim 3, wherein the memory and the at least one processor are further configured to:
receive, from the network node, the plurality of transmit configurations prior to receiving the UL grant for the PUSCH,
wherein the network node specifies associations
between the plurality of transmit configurations and the plurality of HARQ processes,
between the plurality of transmit configurations and the plurality of HARQ process types,
or both, and
wherein the HARQ process is sufficient to determine the transmit configuration to be used.

5. The UE of claim 3, wherein the memory and the at least one processor are further configured to:
receive, from the network node contemporaneously with the UL grant for the PUSCH, a transmit configuration indicator indicating which of the plurality of transmit configurations is the transmit configuration associated with the HARQ process.

6. The UE of claim 5, wherein the UL grant for the PUSCH is included in a downlink control information (DCI) received from the network node, the DCI further including the transmit configuration indicator.

7. The UE of claim 5, wherein the transmit configuration indicator is included in a downlink medium access control (MAC) control element (CE) received from the network node.

8. The UE of claim 3, wherein the transmit configuration defines one or more transmit parameters comprising a combination of one or more of:
power control parameters including a loop index,
a modulation and coding scheme (MCS) table,
a demodulation reference signal (DMRS) pattern,
a time-domain allocation pattern,
a frequency hopping pattern, or
a slot aggregation number.

9. The UE of claim 3,
wherein the UL message comprises an uplink control information (UCI),
wherein the transmit configuration further defines one or more UCI multiplexing parameters for multiplexing the UCI and UL-SCH data on the PUSCH, the one or more UCI multiplexing parameters comprising beta offsets to indicate one or more of resource offsets for different types of UCI, one or more UCI dropping rules, or UCI multiplexing priority, and
wherein the UCI is multiplexed on the PUSCH in accordance with the one or more UCI multiplexing parameters.

10. The UE of claim 3,
wherein the UL message comprises an uplink medium access control (MAC) control element (CE), and
wherein the UL message is transmitted on the PUSCH in response to the associated HARQ process type being the first HARQ process type.

11. A network node, comprising:
a memory; and
at least one processor coupled to the memory,
wherein the memory and the at least one processor are configured to:
send, to a user equipment (UE), an uplink (UL) grant for a physical uplink shared channel (PUSCH) associated with a hybrid automatic repeat request (HARQ) process; and
receive an UL message transmitted by the UE on the PUSCH using a transmit configuration in accordance with the associated HARQ process, the transmit configuration being one of a plurality of transmit configurations, and at least two of the plurality of transmit configurations being different from each other.

12. The network node of claim 11, wherein the network node is a non-terrestrial network (NTN) node.

13. The network node of claim 11,
wherein the HARQ process is one of a plurality of HARQ processes configured in the UE, each of the plurality of HARQ processes being one of a plurality of HARQ process types, each HARQ process type being based on at least a HARQ retransmission status, and
wherein the plurality of HARQ process types includes at least first and second HARQ process types,
the first HARQ process type having the HARQ retransmission status as enabled, and
the second HARQ process type having the HARQ retransmission status as disabled.

14. The network node of claim 13, wherein the memory and the at least one processor are further configured to:
send, to the UE, the plurality of transmit configurations prior to sending the UL grant for the PUSCH,
wherein the network node specifies associations
between the plurality of transmit configurations and the plurality of HARQ processes,
between the plurality of transmit configurations and the plurality of HARQ process types,
or both, and
wherein the HARQ process is sufficient to determine the transmit configuration to be used.

15. The network node of claim 13, wherein the memory and the at least one processor are further configured to:
send, to the UE contemporaneously with the UL grant for the PUSCH, a transmit configuration indicator indicating which of the plurality of transmit configurations is the transmit configuration associated with the HARQ process.

16. The network node of claim 15, wherein the UL grant for the PUSCH is included in a downlink control information (DCI) sent to the UE, the DCI further including the transmit configuration indicator.

17. The network node of claim 15, wherein the transmit configuration indicator is included in a downlink medium access control (MAC) control element (CE) sent to the UE.

18. The network node of claim 13, wherein the transmit configuration defines one or more transmit parameters comprising a combination of one or more of:
power control parameters including a loop index,
a modulation and coding scheme (MCS) table,
a demodulation reference signal (DMRS) pattern,
a time-domain allocation pattern,
a frequency hopping pattern, or
a slot aggregation number.

19. The network node of claim 13,
wherein the UL message comprises an uplink control information (UCI),
wherein the transmit configuration further defines one or more UCI multiplexing parameters for multiplexing the UCI and UL-SCH data on the PUSCH, the one or more UCI multiplexing parameters comprising beta offsets to indicate one or more of resource offsets for different types of UCI, one or more UCI dropping rules, or UCI multiplexing priority, and
wherein the UCI is multiplexed on the PUSCH in accordance with the one or more UCI multiplexing parameters.

20. The network node of claim 13,
wherein the UL message comprises an uplink medium access control (MAC) control element (CE), and
wherein the UL message is received on the PUSCH in response to the associated HARQ process type being the first HARQ process type.

21. A user equipment (UE), comprising:
a memory; and
at least one processor coupled to the memory,
wherein the memory and the at least one processor are configured to:
receive, from a network node, an uplink (UL) grant for a physical uplink shared channel (PUSCH) for a hybrid automatic repeat request (HARQ) process;
receive, from the network node contemporaneously with the UL grant for the PUSCH, a transmit configuration indicator indicating a transmit configuration of a plurality of transmit configurations to be associated with the HARQ process; and
transmit, to the network node, an UL message on the PUSCH using the indicated transmit configuration.

22. The UE of claim 21, wherein each of the plurality of transmit configurations specifies one or more transmit parameters comprising a combination of one or more of:
power control parameters including a loop index,
a modulation and coding scheme (MCS) table,
a demodulation reference signal (DMRS) pattern,
a time-domain allocation pattern,
a frequency hopping pattern, or
a slot aggregation number.

23. The UE of claim 21,
wherein the HARQ process is one of a plurality of HARQ processes configured in the UE, each of the plurality of HARQ processes being one of a plurality of HARQ process types, each HARQ process type being based on at least a HARQ retransmission status, and
wherein the plurality of HARQ process types includes at least first and second HARQ process types,
the first HARQ process type having the HARQ retransmission status as enabled, and
the second HARQ process type having the HARQ retransmission status as disabled.

24. The UE of claim 23, wherein the UL grant for the PUSCH is included in a downlink control information (DCI) received from the network node, the DCI further including the transmit configuration indicator.

25. The UE of claim 23, wherein the transmit configuration indicator is included in a downlink medium access control (MAC) control element (CE) received from the network node.

26. A network node, comprising:
a memory; and
at least one processor coupled to the memory,
wherein the memory and the at least one processor are configured to:
send, to a user equipment (UE), an uplink (UL) grant for a physical uplink shared channel (PUSCH) for a hybrid automatic repeat request (HARQ) process;
send, to the UE contemporaneously with the UL grant for the PUSCH, a transmit configuration indicator indicating which of a plurality of transmit configurations is to be associated with the HARQ process; and
receive, from the UE, an UL message on the PUSCH using the indicated transmit configuration.

27. The network node of claim 26, wherein each of the plurality of transmit configurations specifies one or more transmit parameters comprising a combination of one or more of:
power control parameters including a loop index,
a modulation and coding scheme (MCS) table,
a demodulation reference signal (DMRS) pattern,
a time-domain allocation pattern,
a frequency hopping pattern, or
a slot aggregation number.

28. The network node of claim 26,
wherein the HARQ process is one of a plurality of HARQ processes configured in the UE, each of the plurality of HARQ processes being one of a plurality of HARQ process types, each HARQ process type being based on at least a HARQ retransmission status, and
wherein the plurality of HARQ process types includes at least first and second HARQ process types,
the first HARQ process type having the HARQ retransmission status as enabled, and
the second HARQ process type having the HARQ retransmission status as disabled.

29. The network node of claim 28, wherein the UL grant for the PUSCH is included in a downlink control information (DCI) sent to the UE, the DCI further including the transmit configuration indicator.

30. The network node of claim 28, wherein the transmit configuration indicator is included in a downlink medium access control (MAC) control element (CE) received from the network node.
